(19) United States
(12) Patent Application Publication
(10) Pub. No.: US 2017/0244215 A1
(43) Pub. Date: Aug. 24, 2017

(54) TITANIUM-SAPPHIRE LASER APPARATUS, LASER APPARATUS USED FOR EXPOSURE APPARATUS, AND TITANIUM-SAPPHIRE AMPLIFIER

(71) Applicants: TOKYO UNIVERSITY OF SCIENCE FOUNDATION, Tokyo (JP); GIGAPHOTON INC., Tochigi (JP)

(72) Inventors: Shuntaro WATANABE, Tokyo (JP); Tomoharu NAKAZATO, Tokyo (JP); Takashi ONOSE, Tochigi (JP)

(73) Assignees: TOKYO UNIVERSITY OF SCIENCE FOUNDATION, Tokyo (JP); GIGAPHOTON INC., Tochigi (JP)

(21) Appl. No.: 15/590,113

(22) Filed: May 9, 2017

Related U.S. Application Data
(63) Continuation of application No. PCT/JP2014/084618, filed on Dec. 26, 2014.

(51) Int. Cl. H01S 3/16

(52) U.S. Cl. CPC H01S 3/1625; H01S 3/1636; H01S 3/23

(57) ABSTRACT

A titanium-sapphire laser apparatus may include a continuous wave oscillation laser unit, an amplification oscillator, a pulsed laser unit, an error detector, an error controller, and an optical path length corrector. The amplification oscillator may include an optical resonator and a titanium-sapphire crystal that is provided in an optical path in the optical resonator. The error detector may be provided in an optical path of leak light of seed light from the optical resonator, and may detect an optical path length error between an optical path length in the optical resonator and a positive integer multiple of a wavelength of the seed light and output an optical path length error signal. The optical path length corrector may vary the optical path length in the optical resonator on a basis of a signal resulting from adding a correction value to the optical path error signal.

### CROSS REFERENCE TO RELATED APPLICATIONS

The present application is a continuation application of International Application No. PCT/JP2014/084618 filed on Dec. 26, 2014. The content of the application is incorporated herein by reference in its entirety.

### BACKGROUND

1. Technical Field

The present disclosure relates to a titanium-sapphire laser apparatus using a titanium-sapphire crystal, a laser apparatus used for an exposure apparatus, and a titanium-sapphire amplifier.

2. Related Art

With miniaturization and high integration of a semiconductor integrated circuit, an improvement in resolution has been demanded for a semiconductor exposure apparatus. Hereinafter, the semiconductor exposure apparatus is simply referred to as an “exposure apparatus”. Shortening in a wavelength of light to be outputted from an exposure light source has been in progress accordingly. A gas laser unit is used in place of an existing mercury lamp for the exposure light source. Currently, a KrF excimer laser unit and an ArF excimer laser unit may be used as gas laser units for exposure. The KrF excimer laser unit may output ultraviolet light of a wavelength of 248 nm, and the ArF excimer laser unit may output ultraviolet light of a wavelength of 193 nm.

As current exposure technology, liquid immersion exposure is practically used. In the liquid immersion exposure, a clearance between a projection lens on exposure apparatus side and a wafer is filled with a liquid to change a refractive index of the clearance, thereby shortening an apparent wavelength of light from the exposure light source. When the liquid immersion exposure is performed with use of the ArF excimer laser unit as the exposure light source, ultraviolet light of a wavelength of 134 nm in water is applied to the wafer. This technology is referred to as ArF liquid immersion exposure. The ArF liquid immersion exposure is also referred to as ArF liquid immersion lithography.

Since a spectral line width in free oscillation of each of the KrF excimer laser unit and the ArF excimer laser unit is wide, e.g., in a range from about 350 pm to about 400 pm, color aberration of laser light (ultraviolet light) that is reduced and projected on the wafer by the projection lens on the exposure apparatus side occurs, which results in decrease in resolution. It is therefore necessary to narrow a spectral line width of laser light to be outputted from the gas laser unit to an extent in which the color aberration is negligible. The spectral line width is also referred to as a spectral width. Accordingly, a line narrow module including a line narrowing device is provided in a laser resonator of the gas laser unit, which achieves narrowing of the spectral width. Non-limiting examples of the line narrowing device may include an etalon and a grating. The laser unit narrowed in spectral width in this way is referred to as a line narrowing laser unit. For example, reference is made to Japanese Unexamined Patent Application Publication No. 2013-135075, Japanese Unexamined Patent Application Publication No. 2013-222173, U.S. Patent Application Publication No. 2013/0163073, and U.S. Patent Application Publication No. 2013/0279526.

### SUMMARY

A titanium-sapphire laser apparatus according to one aspect of the present disclosure may include: a continuous wave oscillation laser unit, an amplification oscillator, a pulsed laser unit, an error detector, an error controller, and an optical path length corrector. The continuous wave oscillation laser unit may be configured to perform continuous wave oscillation in a single longitudinal mode to output seed light. The seed light may enter the amplified oscillator. The amplification oscillator may include an optical resonator and a titanium-sapphire crystal. The titanium-sapphire crystal may be provided in an optical path in the optical resonator. The pulsed laser unit may be configured to output pulsed laser light toward the titanium-sapphire crystal. The error detector may be provided in an optical path of leak light of the seed light from the optical resonator, and may be configured to detect an optical path length error between an optical path length in the optical resonator and a positive integer multiple of a wavelength of the seed light and output an optical path length error signal. The error controller may be configured to output a correction value of the optical path length error signal. The optical path length corrector may be configured to vary the optical path length in the optical resonator on a basis of a signal. The signal may result adding the correction value to the optical path error signal.

A laser apparatus according to one aspect of the present disclosure may be used for an exposure apparatus. The laser apparatus may include a master oscillator power oscillator, a first multipass amplifier, and a second multipass amplifier. The master oscillator power oscillator may include a continuous wave oscillation laser unit. The continuous wave oscillation laser unit may be configured to perform continuous wave oscillation in a single longitudinal mode to output seed light. The first multipass amplifier may include a first multipass optical system and a first titanium-sapphire crystal. The first multipass optical system may allow the seed light outputted from the master oscillator power oscillator to reciprocate therethrough, and the first titanium-sapphire crystal may be provided in a first multiple optical path in the first multipass optical system. The second multipass amplifier may include a second multipass optical system and a second titanium-sapphire crystal. The second multipass optical system may allow the seed light outputted from the first multipass amplifier to reciprocate therethrough, and the second titanium-sapphire crystal may be provided in a second multiple optical path in the second multipass optical system. The number of reciprocations of the seed light in the second multipass amplifier may be equal to or smaller than the number of reciprocations of the seed light in the first multipass amplifier.

A titanium-sapphire amplifier according to one aspect of the present disclosure may include a titanium-sapphire crystal, a multipass optical system, a first dichroic mirror, and a second dichroic mirror. The multipass optical system may include a plurality of light condensing optical devices. The multipass optical system may be configured to allow seed light having entered via a predetermined entry position to pass through the titanium-sapphire crystal an even number of times and may be configured to allow an incident beam image at the predetermined entry position to be transferred by the plurality of light condensing optical devices an even number of times to form an image of the incident beam image. The first dichroic mirror may be provided in an optical path of the seed light in the multipass optical system and may be provided to allow excitation light to enter the titanium-sapphire crystal. The second dichroic mirror may be provided in the optical path of the seed light in the multipass optical system and may be provided to allow the excitation light outputted from the titanium-sapphire crystal to be outputted to outside of the multipass optical system.

### BRIEF DESCRIPTION OF THE DRAWINGS

Some example embodiments of the present disclosure are described below as mere examples with reference to the accompanying drawings.

FIG. 1 schematically illustrates a configuration example of a laser apparatus used for an exposure apparatus according to a comparative example.

FIG. 2 schematically illustrates a configuration example of a narrow-band titanium-sapphire laser apparatus according to the comparative example.

FIG. 3 illustrates an example of variation with time in an optical path length error in an optical resonator in the narrow-band titanium-sapphire laser apparatus illustrated in FIG. 2 in a case in which the optical path length error is not corrected.

FIG. 4 illustrates an example of variation with time in the optical path length error in the optical resonator in the narrow-band titanium-sapphire laser apparatus illustrated in FIG. 2 in a case in which the optical path length error is corrected.

FIG. 5 illustrates an example of variation in focal length by a thermal lens effect in a titanium-sapphire crystal.

FIG. 6 schematically illustrates a configuration example of a master oscillator power oscillator (MOPO) in a narrow-band titanium-sapphire laser apparatus according to a first embodiment.

FIG. 7 illustrates an example of variation with time in an optical path length error in an optical resonator in the narrow-band titanium-sapphire laser apparatus illustrated in FIG. 6 in a case in which the optical path length error is corrected.

FIG. 8 is a main flow chart schematically illustrating an example of a flow of control of an optical path length in the optical resonator in the narrow-band titanium-sapphire laser apparatus illustrated in FIG. 6.

FIG. 9 is a sub-flow chart illustrating details of a process in step S105 of the main flow chart illustrated in FIG. 8.

FIG. 10 schematically illustrates an example of a method of measuring a minimum value of an optical path length error.

FIG. 11 schematically illustrates a configuration example of a multipass titanium-sapphire amplifier in the narrow-band titanium-sapphire laser apparatus according to the first embodiment.

FIG. 12 schematically illustrates an optical equivalent diagram of a multipass optical system in the multipass titanium-sapphire amplifier illustrated in FIG. 11.

FIG. 13 schematically illustrates a first modification example of the multipass titanium-sapphire amplifier illustrated in FIG. 11.

FIG. 14 schematically illustrates a second modification example of the multipass titanium-sapphire amplifier illustrated in FIG. 11.

FIG. 15 schematically illustrates a configuration example of an MOPO in a narrow-band titanium-sapphire laser apparatus according to a second embodiment.

FIG. 16 schematically illustrates a configuration example of a multipass amplifier unit in the narrow-band titanium-sapphire laser apparatus according to the second embodiment.

FIG. 17 illustrates an example of amplification characteristics of the multipass amplifier unit illustrated in FIG. 16.

FIG. 18 schematically illustrates a modification example of the multipass amplifier unit illustrated in FIG. 16.

FIG. 19 schematically illustrates a configuration example of an optical path length error detector.

FIG. 20 schematically illustrates a configuration example of an optical shutter.

FIG. 21 illustrates an example of a hardware environment of a controller.

### DETAILED DESCRIPTION

### <Contents>

### [1. Overview]

### [2. Comparative Examples]

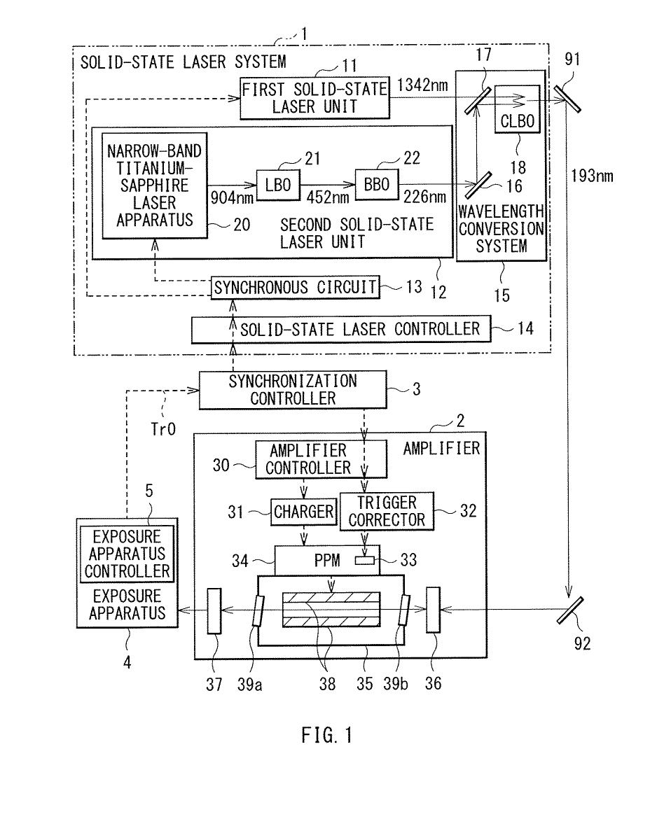

2.1 Laser Apparatus Used for Exposure Apparatus
2.1.1 Configuration (FIG. 1)
2.1.2 Operation

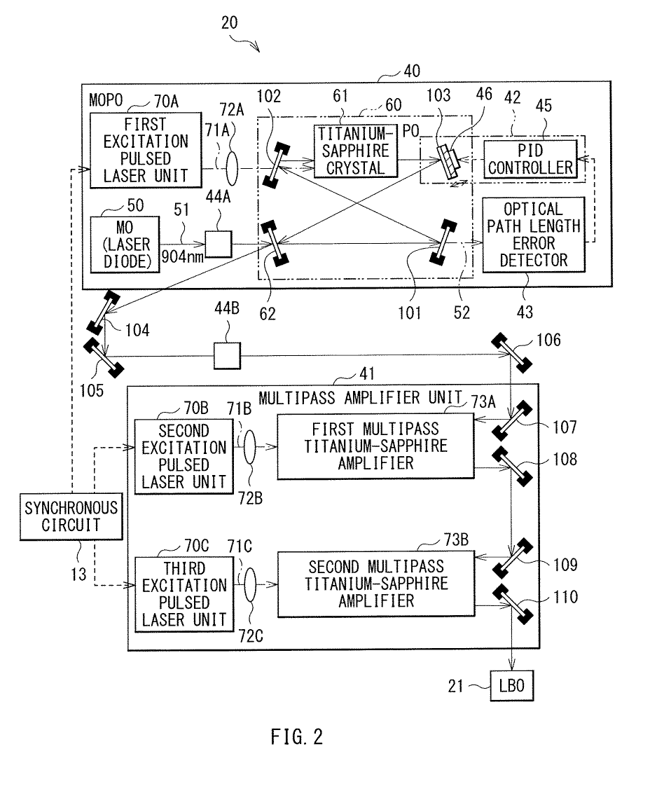

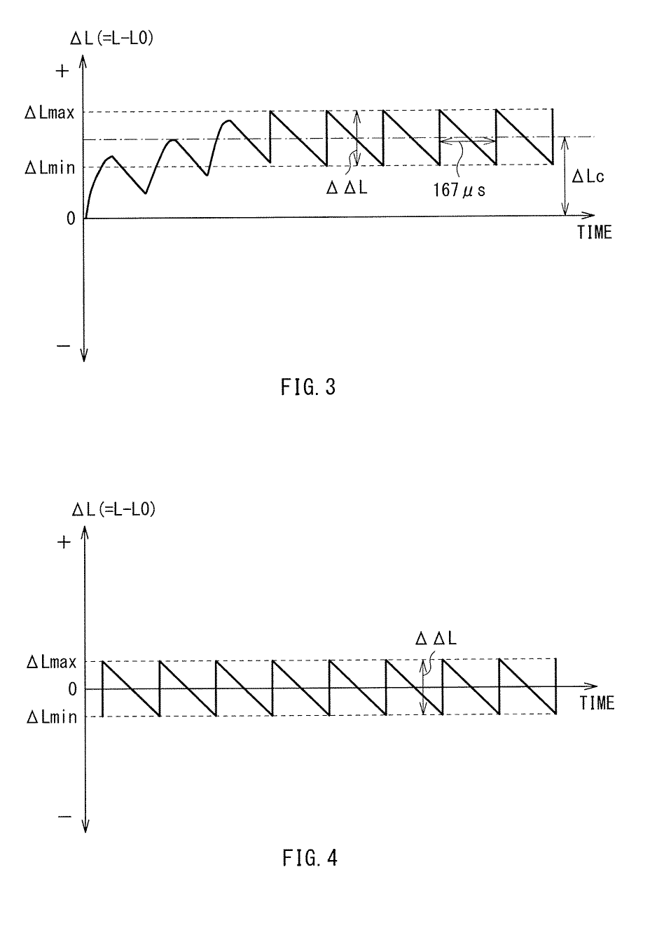

2.2 Narrow-Band Titanium-Sapphire Laser Apparatus
2.2.1 Configuration (FIG. 2)
2.2.2 Operation
2.2.3 Issues (FIGS. 3 to 5)

### [3. First Embodiment]

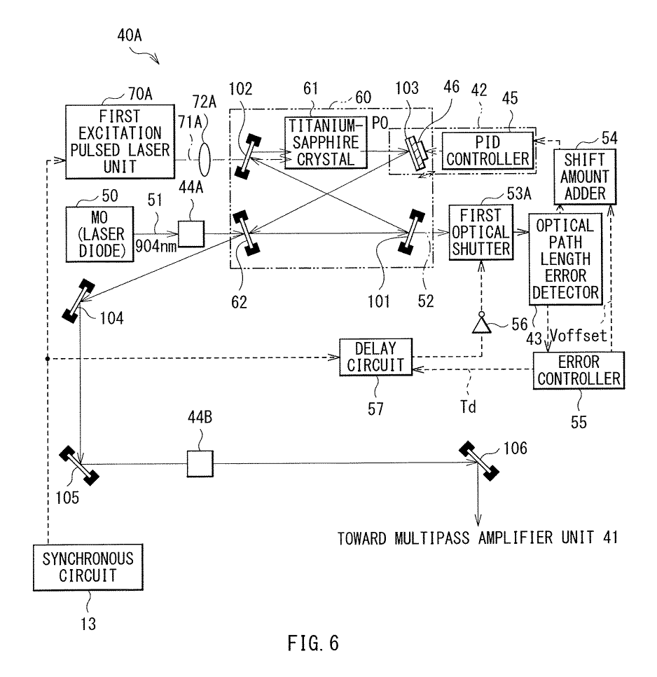

3.1 MOPO (FIGS. 6 to 10)
3.1.1 Configuration
3.1.2 Operation
3.1.3 Effect

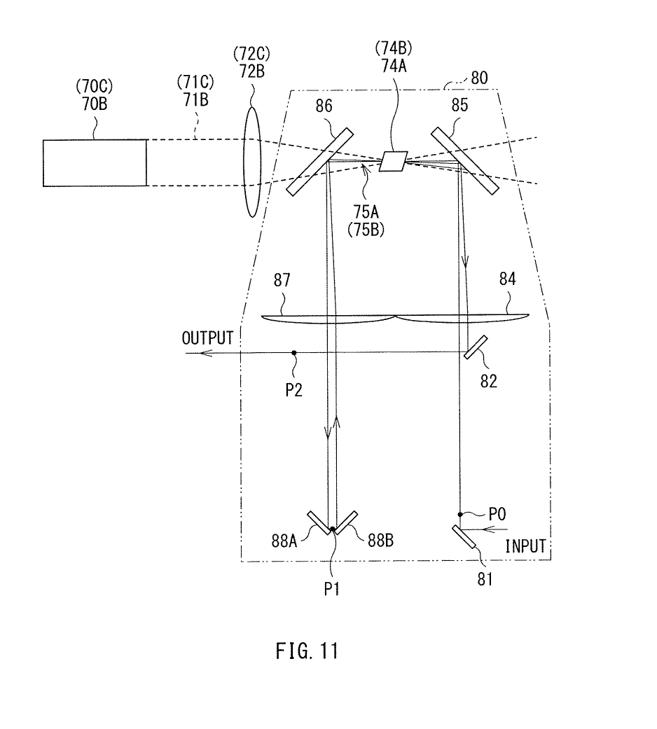

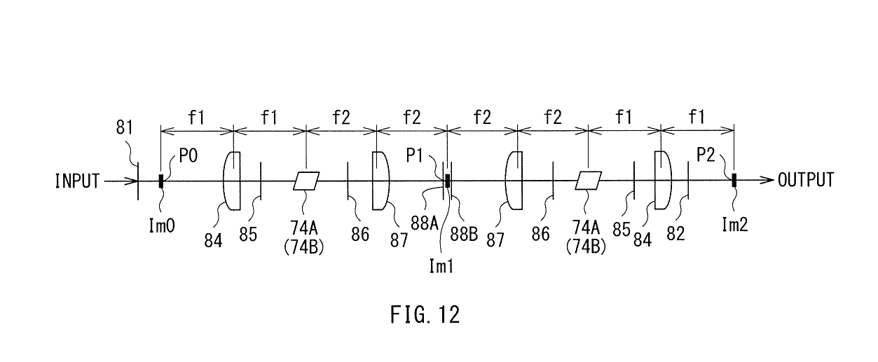

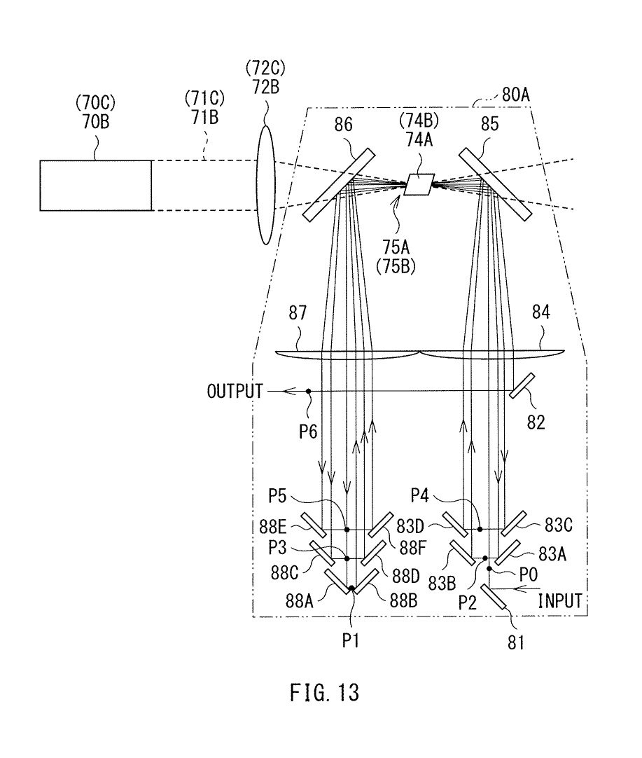

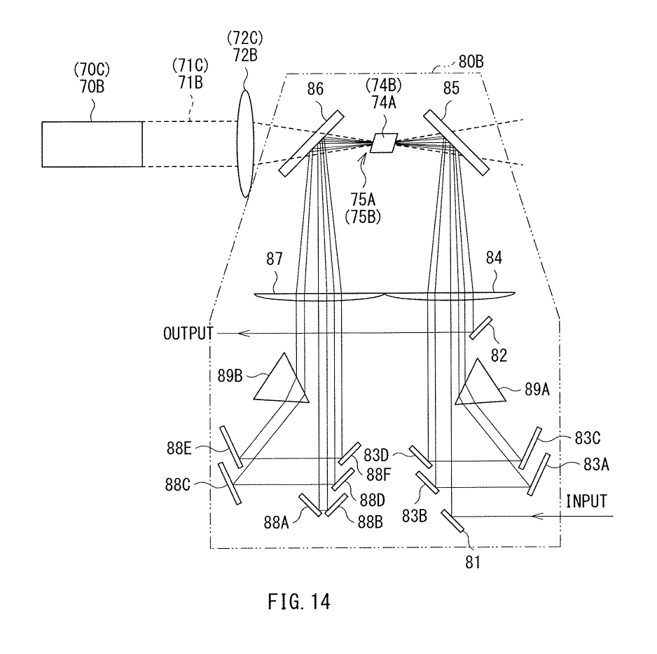

3.2 Multipass Amplifier Unit
3.2.1 Configuration (FIGS. 11 and 12)
3.2.2 Operation
3.2.3 Effect
3.2.4 Modification Examples
   3.2.4.1 First Modification Example (FIG. 13)
   3.2.4.2 Second Modification Example (FIG. 14)

### [4. Second Embodiment]

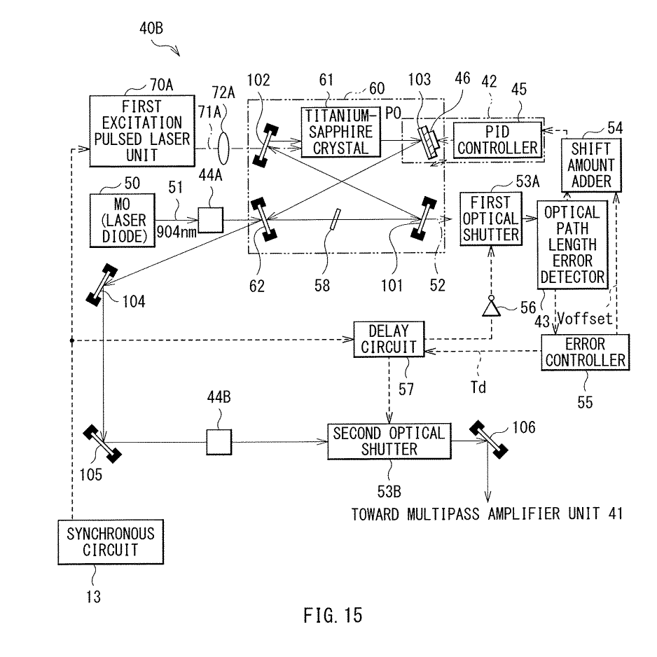

4.1 MOPO (FIG. 15)
4.1.1 Configuration
4.1.2 Effect

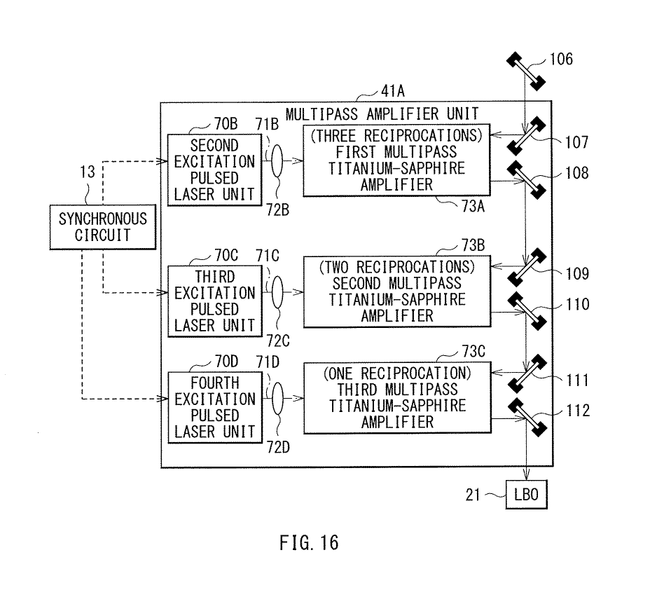

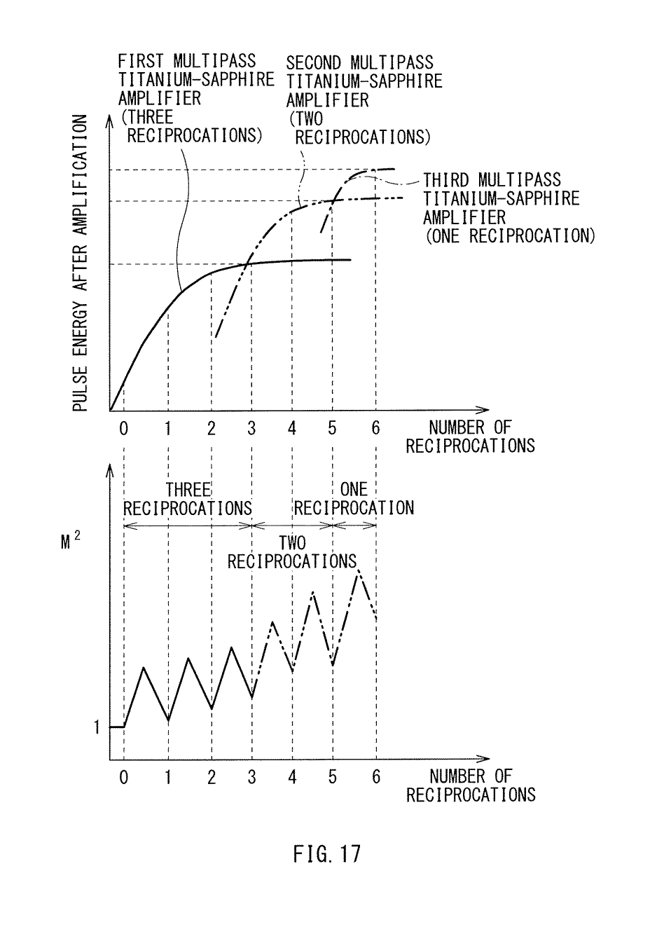

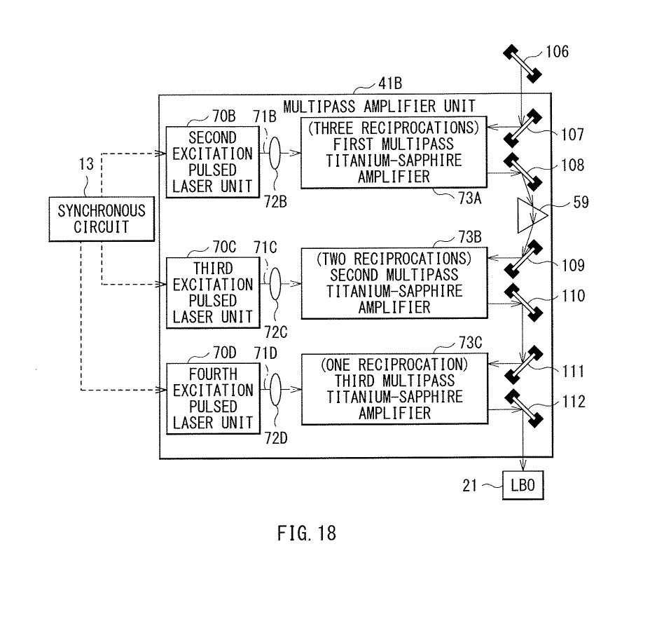

4.2 Multipass Amplifier Unit
4.2.1 Configuration (FIG. 16)
4.2.2 Operation and Effect (FIG. 17)
4.2.3 Modification Example (FIG. 18)

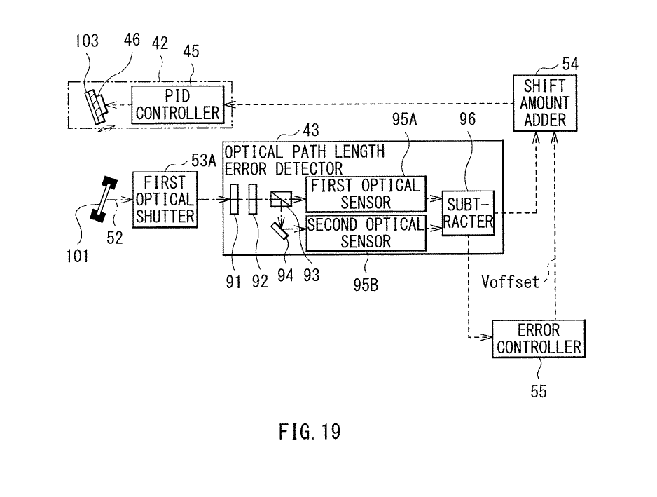

### [5. Configuration Example of Optical Path Length Error Detector] (FIG. 19)

5.1 Configuration

5.2 Operation

5.3 Modification Examples

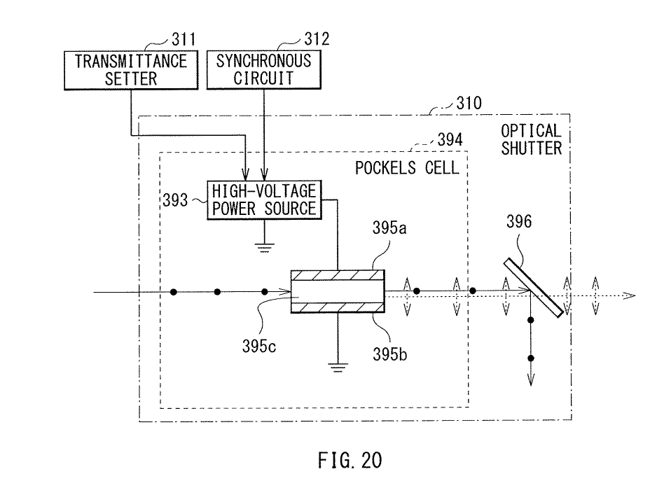

### [6. Configuration Example of Optical Shutter] (FIG. 20)

6.1 Configuration

6.2 Operation

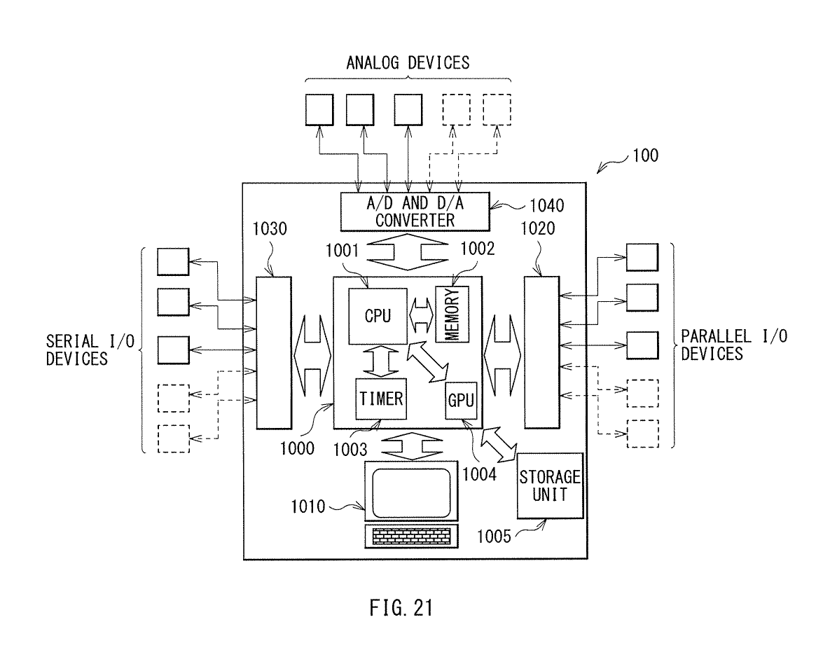

### [7. Hardware Environment of Controller] (FIG. 21)

### [8. Et Cetera]

In the following, some example embodiments of the present disclosure are described in detail with reference to the drawings. Example embodiments described below each illustrate one example of the present disclosure and are not intended to limit the contents of the present disclosure. Further, all of the configurations and operations described in each example embodiment are not necessarily essential for the configurations and operations of the present disclosure. Note that like components are denoted by like reference numerals, and redundant description thereof is omitted.

### 1. Overview

The present disclosure relates to a titanium-sapphire laser apparatus using a titanium-sapphire crystal and a laser apparatus used for an exposure apparatus, for example.

### 2. Comparative Examples

First, description is given of a titanium-sapphire laser apparatus and a laser apparatus used for an exposure apparatus according to a comparative example with respect to example embodiments of the present disclosure.

### (2.1 Laser Apparatus Used For Exposure Apparatus)

(2.1.1 Configuration)

FIG. 1 schematically illustrates a configuration example of the laser apparatus used for the exposure apparatus according to the comparative example with respect to example embodiments of the present disclosure.

The laser apparatus used for the exposure apparatus may include a solid-state laser system 1, an amplifier 2, a synchronization controller 3, and high reflection mirrors 91 and 92.

The solid-state laser system 1 may include a first solid-state laser unit 11, a second solid-state laser unit 12, a synchronous circuit 13, a solid-state laser controller 14, and a wavelength conversion system 15.

The first solid-state laser unit 11 may be a Nd:YVO₄ pulsed laser unit, and may perform oscillation in a single longitudinal mode. The Nd:YVO₄ pulsed laser unit may output pulsed laser light of a wavelength of 1342 nm. The second solid-state laser unit 12 may include a narrow-band titanium-sapphire laser apparatus 20, an LBO (LIB₃O₅) crystal 21, and a BBO (β-BaB₂O₄) crystal 22. The narrow-band titanium-sapphire laser apparatus 20 may perform oscillation at a wavelength of 904 nm.

The wavelength conversion system 15 may include a high reflection mirror 16, a beam splitter 17, and a CLBO (CsLiB₆O₁₀) crystal 18.

For example, the solid-state laser controller 14 may be configured to enable transmission and startup of data and transmission of a stop signal to the first solid-state laser unit 11 and the second solid-state laser unit 12 in accordance with an unillustrated control signal.

The synchronous circuit 13 may be configured to allow first pulsed laser light outputted from the first solid-state laser unit 11 and second pulsed laser light outputted from the second solid-state laser unit 12 to enter the CLBO crystal 18 of the wavelength conversion system 15 substantially simultaneously.

The amplifier 2 may include an amplifier controller 30, a charger 31, a trigger corrector 32, a pulsed power module (PPM 34 including a switch 33, a chamber 35, a partial reflection mirror 36, and an output coupling mirror 37.

The chamber 35 may be provided with windows 39a and 39b. The chamber 35 may contain, for example, a laser gas containing an Ar gas, a F₂ gas, and a Ne gas. A pair of discharge electrodes 38 may be provided inside the chamber 35. The pair of discharge electrodes 38 may be coupled to an output terminal of the PPM 34.

In the amplifier 2, an optical resonator including the partial reflection mirror 36 and the output coupling mirror 37 may be configured. The partial reflection mirror 36 may be configured of, for example, a substrate made of a CaF₂ crystal coated with a partial reflection film having reflectivity from 70% to 90% both inclusive. The substrate may allow, for example, light of a wavelength of 193 nm to pass therethrough. The output coupling mirror 37 may be configured of, for example, a substrate made of a CaF₂ crystal coated with a partial reflection film having reflectivity from 10% to 20% both inclusive. The substrate may allow, for example, light of a wavelength of 193 nm to pass therethrough.

An oscillation trigger Tr0 may be inputted from an exposure apparatus controller 5 of an exposure apparatus 4. The synchronization controller 3 may be configured to output an oscillation trigger to the trigger corrector 32 via amplifier controller 30 so as to cause the pair of discharge electrodes 38 to perform discharge in synchronization with injection of pulsed laser light of a wavelength of 193 nm from the solid-state laser system 1 into the optical resonator of the amplifier 2.

### (2.1.2 Operation)

The solid-state laser controller 14 may prepare for operations of the first solid-state laser unit 11 and the second solid-state laser unit 12 so as to allow for output of pulsed laser light from the first solid-state laser unit 11 and the second solid-state laser unit 12. The synchronization controller 3 may output an oscillation trigger to the synchronous circuit 13 via the solid-state laser controller 14 of the solid-state laser system 1 at a predetermined timing upon reception of the oscillation trigger Tr0 from the exposure apparatus controller 5 of the exposure apparatus 4. The synchronization controller 3 may also output an oscillation trigger to the trigger corrector 32 via the amplifier controller 30 of the amplifier 2 at a predetermined timing upon reception of the oscillation trigger Tr0 from the exposure apparatus controller 5 of the exposure apparatus 4.

The synchronous circuit 13 may output an oscillation trigger to each of the first solid-state laser unit 11 and the narrow-band titanium-sapphire laser apparatus of the second solid-state laser unit 12 at a predetermined timing. The first solid-state laser unit 11 may output the first pulsed laser light of a wavelength of 1342 nm.

In the second solid-state laser unit 12, when the oscillation trigger is inputted to the narrow-band titanium-sapphire laser apparatus 20, the narrow-band titanium-sapphire laser apparatus 20 may output pulsed laser light of a wavelength of 904 nm. Thereafter, the LBO crystal 21 and the BBO crystal 22 may generate the second pulsed laser light that is a fourth harmonic of a wavelength of 226 nm. The first pulsed laser light of a wavelength of 1342 nm outputted from the first solid-state laser unit 11 and the second pulsed laser light of a wavelength of 226 nm outputted from the second solid-state laser unit 12 may enter the wavelength conversion system 15.

In the wavelength conversion system 15, the high reflection mirror 16 and the beam splitter 17 may cause the first pulsed laser light and the second pulsed laser light to enter the CLBO crystal 18 substantially simultaneously and be superimposed on each other on the CLBO crystal 18. The CLBO crystal 18 may generate pulsed laser light of a wavelength of 193 nm as a sum frequency of a wavelength of 226 nm and a wavelength of 1342 nm. The pulsed laser light may enter the partial reflection mirror 36 of the amplifier 2 via the high reflection mirrors 91 and 92.

The pulsed laser light may be injected as seed light into the optical resonator including the output coupling mirror 37 and the partial reflection mirror 36 of the amplifier 2. Discharge by the pair of discharge electrodes 38 may produce a population inversion in the chamber 35 of the amplifier 2 in synchronization with such injection. At this occasion, the trigger corrector 32 may adjust a timing of the switch 33 of the PPM 34 so as to efficiently amplify, in the amplifier 2, the pulsed laser light of a wavelength of 193 nm from the solid-state laser system 1. As a result, pulsed laser light may be amplified and oscillated by the optical resonator of the amplifier 2, and the thus-amplified pulsed laser light may be outputted from the output coupling mirror 37.

### (2.2 Narrow-Band Titanium-Sapphire Laser Apparatus)

(2.2.1 Configuration)

FIG. 2 schematically illustrates a configuration example of a narrow-band titanium-sapphire laser apparatus 20 according to the comparative example with respect to example embodiments of the present disclosure.

The narrow-hand titanium-sapphire laser apparatus 20 may include a master oscillator power oscillator (MOPO) 40, a fourth high reflection mirror 104, a fifth high reflection mirror 105, a second optical isolator 44B, a sixth high reflection mirror 106, and a multipass amplifier unit 41.

The MOPO 40 may include a master oscillator (MO) 50 and a power oscillator (PO: amplifier oscillator) 60. The MOPO 40 may further include a first optical isolator 44A, a first excitation pulsed laser unit 70A, a first condenser lens 72A, an optical path length corrector 42, and an optical path length error detector 43.

The MO 50 may be a continuous wave (CW) oscillation laser unit configured to perform CW oscillation in a single longitudinal mode. The MO 50 may be, for example, a distributed-feedback laser diode. The distributed-feedback laser diode may perform CW oscillation in the single longitudinal mode to output seed light 51 of a wavelength of 904 nm. The first optical isolator 44A may be provided in an optical path between the MO 50 and the PO 60. The first optical isolator 44 may be adopted to suppress transmission of return light.

The first excitation pulsed laser unit 70A may be a pulsed laser unit configured to output first pulsed laser light 71A of a wavelength of 523 nm. The first pulsed laser light 71A may be used for excitation. The first pulsed laser light 71A may be a second harmonic of Nd:YLF pulsed laser light.

The PO 60 may include an optical resonator and a titanium-sapphire crystal 61. The titanium-sapphire crystal 61 may be provided in an optical path in the optical resonator. Both end surfaces of the titanium-sapphire crystal 61 may be cut so as to allow light to enter the end surfaces at a Brewster's angle. The seed light 51 and the first pulsed laser light 71A used for excitation may enter the PO 60. The optical resonator of the PO 60 may be a Z-type ring optical resonator, and may include an output coupling mirror 62, a first high reflection mirror 101, a second high reflection mirror 102, and a third high reflection mirror 103.

The first high reflection mirror 101 may be configured of a substrate coated with a film. The substrate may allow light of a wavelength of 904 nm to pass therethrough, and the film may reflect light of a wavelength of 904 nm at high reflectivity, but may allow part of the light to pass therethrough. The optical path length error detector 43 may be provided in an optical path of leak light 52 of seed light 51 from the first high reflection mirror 101 so as to allow the leak light 52 to enter the optical path length error detector 43.

The second high reflection mirror 102 may be a dichroic mirror that allows the first pulsed laser light 71A serving as excitation light to pass therethrough at high transmittance and reflects the seed light 51 of a wavelength of 904 nm at high reflectivity.

The third high reflection mirror 103 may be a mirror that reflects light of a wavelength of 904 nm at high reflectivity. The third high reflection mirror 103 may be fixed to a piezoelectric-device-equipped mirror holder 46 including a piezoelectric device. A direction of mirror movement by the piezoelectric device may be substantially coincident with a direction of a normal to a mirror surface.

The first excitation pulsed laser unit 70A and the first condenser lens 72A may be provided so as to allow the first pulsed laser light 71A used for excitation to be condensed on the titanium-sapphire crystal 61 via the first high reflection mirror 101.

The optical path length corrector 42 may include the piezoelectric-device-equipped mirror holder 46, the third high reflection mirror 103, and a proportional integral derivative (RID) controller 45.

The PID controller 45 may be configured to control a position of the third high reflection mirror 103. An output signal of the optical path length error detector 43 may be inputted to the PID controller 45.

The seed light 51 amplified by the PO 60 may be outputted via the output coupling mirror 62. The fourth high reflection mirror 104, the fifth high reflection mirror 105, the second optical isolator 44B, and the sixth high reflection mirror 106 may be provided so as to allow the amplified seed light 51 to enter the multipass amplifier unit 41 via the fourth high reflection mirror 104, the fifth high reflection mirror 105, the second optical isolator 44B, and the sixth high reflection mirror 106. The second optical isolator 44B may be provided to suppress transmission of return light.

The multi pass amplifier unit 41 may include a second excitation pulsed laser unit 70B, a third excitation pulsed laser unit 70C, a second condenser lens 72B, and a third condenser lens 72C. The multipass amplifier unit 41 may further include a first multipass titanium-sapphire amplifier 73A, a second multipass titanium-sapphire amplifier 73B, and seventh to tenth high reflection mirrors 107 to 110.

The second excitation pulsed laser unit 70B may be a pulsed laser unit configured to output second pulsed laser light 71B of a wavelength of 523 nm. The second pulsed laser light 71B may be used for excitation. The second pulsed laser light 71B may be a second harmonic of Nd:YLF pulsed laser light. The third excitation pulsed laser unit 70C may be a pulsed laser unit configured to output third pulsed laser light 71C of a wavelength of 523 nm. The third pulsed laser light 71C may be used for excitation. The third pulsed laser light 71C may be a second harmonic of Nd:YLF pulsed laser light.

The first multipass titanium-sapphire amplifier 73A may include a first titanium-sapphire crystal 74A as with an after-mentioned embodiment illustrated in FIG. 11. The first titanium-sapphire crystal 74A may be different from the titanium-sapphire crystal 61. The second multipass titanium-sapphire amplifier 73B may include a second titanium-sapphire crystal 74B as with the after-mentioned embodiment illustrated in FIG. 11. The second titanium-sapphire crystal 74B may be different from the titanium-sapphire crystal 61.

The first, second, and third excitation pulsed laser units 70A, 70B, and 70C may be configured so as to receive an oscillation trigger from the synchronous circuit 13.

### (2.2.2 Operation)

The MO 50 may perform CW oscillation in the single longitudinal mode to output the seed light 51. The seed light 51 may be inputted to the output coupling mirror 62 to the optical resonator of the PO 60 via the first optical isolator 44A. The seed light 51 may travel around an optical path of the optical resonator of the PO 60. This may cause leak light 52 of the seed light 51 to be outputted from the first high reflection mirror 101.

The leak light 52 may be inputted to the optical path length error detector 43, and the optical path length error detector 43 may output an optical path length error signal. The optical path length error signal may be a signal indicating an optical path length error ΔL (=L−L0) between a positive integer multiple L0 of a wavelength of the seed light 51 and an actual optical path length L in the optical resonator. The optical path length error detector 43 may output, for example, a voltage V as the optical path length error signal. The voltage V may be equal to K·ΔL, where K may be a proportional constant. The optical path length may be an optical length that also takes account of a refractive index.

The PID controller 45 may receive the voltage V indicating the optical path length error ΔL and may perform PID control of a position of the third high reflection mirror 103 so as to allow the voltage V, i.e., the optical path length error ΔL, to approach zero.

Thereafter, when an oscillation trigger is inputted from the synchronous circuit 13 to the first excitation pulsed laser unit 70A, the first pulsed laser light 71A used for excitation may be outputted to excite the titanium-sapphire crystal 61 of the PO 60 in a form of pulse. Since the seed light 51 has been already injected into the titanium-sapphire crystal 61, the seed light 51 may be amplified in the form of pulse. As a result, the seed light 51 may be subjected to laser oscillation in the optical resonator to be modified in the form of pulse, and the modified seed light 51 may be outputted from the output coupling mirror 62.

The seed light 51 amplified in the form of pulse may enter the multipass amplifier unit 41 via the fourth high reflection mirror 104, the fifth high reflection mirror 105, the second optical isolator 44B, and the sixth high reflection mirror 106.

The seed light 51 of a wavelength of 904 nm amplified in the form of pulse may enter the after-mentioned first titanium-sapphire crystal 74A illustrated in FIG. 11 in the first multipass titanium-sapphire amplifier 73A via the seventh high reflection mirror 107. In synchronization with a timing of entry of the seed light 51, the second pulsed laser light 71B serving as excitation light may enter the after-mentioned first titanium-sapphire crystal 74A from the second excitation pulsed laser unit 70B to excite the seed light 51 in the form of pulse. In the first multipass titanium-sapphire amplifier 73A, multiple passing of pulsed laser light of a wavelength of 904 nm through the after-mentioned first titanium-sapphire crystal 74A may amplify the seed light 51 a plurality of times.

The seed light 51 amplified in the form of pulse by the first multipass titanium-sapphire amplifier 73A may enter the second multipass titanium-sapphire amplifier 73B via the eighth high reflection mirror 108 and the ninth high reflection mirror 109. In the second multipass titanium-sapphire amplifier 73B, the seed light 51 of a wavelength of 904 nm amplified in the form of pulse may enter the after-mentioned second titanium-sapphire crystal 74B illustrated in FIG. 11. In synchronization with a timing of entry of the seed light 51, the third pulsed laser light 71C serving as excitation light may enter the after-mentioned second titanium-sapphire crystal 74B from the third excitation pulsed laser unit 70C to excite the seed light 51 in the form of pulse. In the second multipass titanium-sapphire amplifier 73B, multiple passing of pulsed laser light of a wavelength of 904 nm through the after-mentioned second titanium-sapphire crystal 74B may amplify the seed light 51 a plurality of times.

The seed light 51 amplified by the second multipass titanium-sapphire amplifier 73B may enter the LBO crystal 21 via the tenth high reflection mirror 110.

### (2.2.3 Issues)

(Issues of Control of Optical Path Length in Optical Resonator of PO 60)

FIG. 3 illustrates an example of variation with time in the optical path length error ΔL in the optical resonator of the PO 60 in the narrow-band titanium-sapphire laser apparatus 20 illustrated in FIG. 2 in a case in which the optical path length error ΔL is not corrected. FIG. 3 illustrates variation with time immediately after start of excitation in the PO 60. A horizontal axis and a vertical axis in FIG. 3 indicate time and the optical path length error ΔL, respectively.

In a state before the start of excitation, variation in temperature of the titanium-sapphire crystal 61 is small. Hence, the optical path length error ΔL (=L−L0) is close to 0. However, when excitation starts at 6 kHz, the optical path length error ΔL may vary while being gradually drifted by ΔLc toward “+” side, and a maximum value Lmax and a minimum value Lmin may be alternately repeated for each excitation pulse.

FIG. 4 illustrates an example of variation with time in the optical path length error ΔL in the optical resonator of the PO 60 in the narrow-hand titanium-sapphire laser apparatus 20 illustrated in FIG. 2 in a case in which the optical path length error ΔL is corrected. FIG. 4 illustrates variation with time immediately after start of excitation in the PO 60. A horizontal axis and a vertical axis in FIG. 4 indicate time and the optical path length error ΔL, respectively,

In order to suppress divergence of control, the PID controller 45 of the optical path length corrector 42 may perform control so as to allow an integral of an error signal to approach zero. Hence, while it may be possible to perform control to allow a ΔLC component to approach zero, it may be difficult to suppress variation ΔΔL (=ΔLmax−ΔLmin) for each excitation pulse. A reason for this is that it may not be possible for speed of variation in the optical path length to follow response speed of the optical path length corrector 42 in some cases. As a result, the refractive index varies by variation in the temperature of the titanium-sapphire crystal 61 every time the first pulsed laser light 71A used for excitation is inputted to the titanium-sapphire crystal 61, which may make it difficult for the optical path length in the optical resonator to be coincident with an optical path length of a positive integer multiple of the wavelength of the seed light 51. Accordingly, an output timing and a pulse waveform of the seed light 51 amplified in the form of pulse and outputted from the output coupling mirror 62 may become unstable.

### (Issues of Multipass Amplifier Unit 41)

In the first and second multipass titanium-sapphire amplifiers 73A and 73B, gains of the after-mentioned first and second titanium-sapphire crystals 74A and 74B illustrated in FIG. 11 are small at a wavelength of 904 nm; therefore, in order to increase the gains; it may be necessary to condense excitation light. When an attempt to increase output is made under such a condition, a refractive index distribution may be created by a temperature distribution in the after-mentioned first and second titanium-sapphire crystals 74A and 74B, and the refractive index distribution may serve as a thermal lens. As output of the excitation light entering each of the first and second titanium-sapphire crystals 74A and 74B increases, the focal length by a thermal lens effect may be shortened.

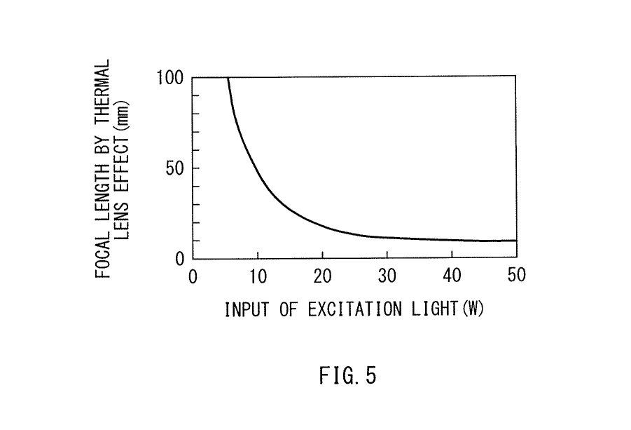

FIG. 5 illustrates an example of a focal length by the thermal lens effect in the titanium-sapphire crystal. A horizontal axis and a vertical axis in FIG. 5 indicate input of excitation light (W) and the focal length by the thermal lens effect (mm), respectively.

In order to increase gains of the after-mentioned first and second titanium-sapphire crystals 74A and 74B, it may be necessary to condense high-output excitation light on a small region of each of the first and second titanium-sapphire crystals 74A and 74B. For example, a condensing diameter from 100 μm to 200 μm both inclusive may be necessary. In this case, the focal length of the thermal lens by the thermal lens effect created in each of the first and second titanium-sapphire crystals 74A and 74B may be shortened. As illustrated in FIG. 5, as input of the excitation light increases, the focal length by the thermal lens effect may be shortened.

When the focal length of the thermal lens by the thermal lens effect is about 10 mm or less, it may not be possible to suppress deterioration in beam characteristics after amplification even though a position of an optical device of an optical system for multiple passing through the first and second titanium-sapphire crystals 74A and 74B is adjusted. In particular, when the number of times of multiple passing of the seed light 51 in the first and second multipass titanium-sapphire amplifiers 73A and 73B increases, deterioration in beam characteristics may be pronounced by the thermal lens effect.

### 3. First Embodiment

Next, description is given of a titanium-sapphire laser apparatus and a laser apparatus used for an exposure apparatus according to a first embodiment of the present disclosure. Note that substantially same components as the components of the foregoing titanium-sapphire laser apparatus and the foregoing laser apparatus used for the exposure apparatus according to the comparative example illustrated in FIGS. 1 and 2 are denoted by same reference numerals, and redundant description thereof is omitted.

A basic configuration of the laser apparatus used for the exposure apparatus according to the present embodiment may be substantially similar to that of the laser apparatus used for the exposure apparatus illustrated in FIG. 1.

### (3.1 MOPO)

(3.1.1 Configuration)

FIG. 6 schematically illustrates a configuration example of an MOPO 40A as a configuration of a main part of the narrow-band titanium-sapphire laser apparatus 20 according to the first embodiment of the present disclosure.

The narrow-band titanium-sapphire laser apparatus 20 according to the present embodiment may include the MOPO 40A in place of the MOPO 40 in the configuration of the comparative example illustrated in FIG. 2. The MOPO 40A may include a first optical shutter 53A and a shift amount adder 54. The narrow-band titanium-sapphire laser apparatus 20 according to the present embodiment may further include an inverter 56, a delay circuit 57, and an error controller 55 in addition to the configuration of the comparative example illustrated in FIG. 2.

The first optical shutter 53A may be provided in an optical path of leak light 52 between the first high reflection mirror 101 and the optical path length error detector 43. The first optical shutter 53A may be subjected to shutter control in which the first optical shutter 53A is closed during entry of the first pulsed laser light 71A into the titanium-sapphire crystal 61 and the first optical shutter 53A is opened during non-entry of the first pulsed laser light 71A into the titanium-sapphire crystal 61.

The shift amount adder 54 may be provided in a signal line between the optical path length error detector 43 and the PID controller 45.

The error controller 55 may transmit data of a correction value Voffset to the shift amount adder 54 on a basis of an optical path length error signal outputted from the optical path length error detector 43.

The delay circuit 57 may receive an oscillation trigger of the synchronous circuit 13 and output a signal for control of opening and closing of the first optical shutter 54A via the inverter 56 after a predetermined delay time. Delay data Td that sets a delay time may be inputted from the error controller 55 to the delay circuit 57.

The optical path length corrector 42 may vary the optical path length in the optical resonator of the PO 60 to allow the optical path length error ΔL to approach zero at a timing immediately before entry of the first pulsed laser light 71 used for excitation into the titanium-sapphire crystal 61.

### (3.1.2 Operation)

The error controller 55 may transmit the delay data Td to the delay circuit 57 to delay an opening-closing timing of the first optical shutter 53A with respect to an oscillation trigger from the synchronous circuit 13. The delay data Td may set the delay time. The error controller 55 may control the first optical shutter 53A so as to prevent the leak light 52 of the seed light 51 amplified in the form of pulse from being detected by the optical path length error detector 43 in synchronization with the first pulsed laser light 71A used for excitation. In this case, the error controller 55 may control the delay circuit 57 so as to close the first optical shutter 53A during entry of the first pulsed laser light 71A into the titanium-sapphire crystal 61. The error controller 55 may further control the delay circuit 57 so as to open the first optical shutter 53A during non-entry of the first pulsed laser light 71A into the titanium-sapphire crystal 61. As described above, the first optical shutter 53A may be controlled so as to be closed during entry of the seed light 51 amplified in the form of pulse and to be opened during non-entry of the seed light 51 amplified in the form of pulse.

The error controller 55 may read data of variation with time in the optical path length error ΔL from the optical path length error detector 43, and may transmit data of the correction value Voffset to the shift amount adder 54 so as to allow the minimum value ΔLmin of the optical path length error ΔL to approach zero. Thus, a voltage value resulting from adding the correction value Voffset from the shift amount adder 54 to the voltage V serving as the optical path length error signal from the optical path length error detector 43 may be inputted to the PID controller 45. Repeating such control may allow the minimum value ΔLmin of the optical path length error ΔL to approach zero.

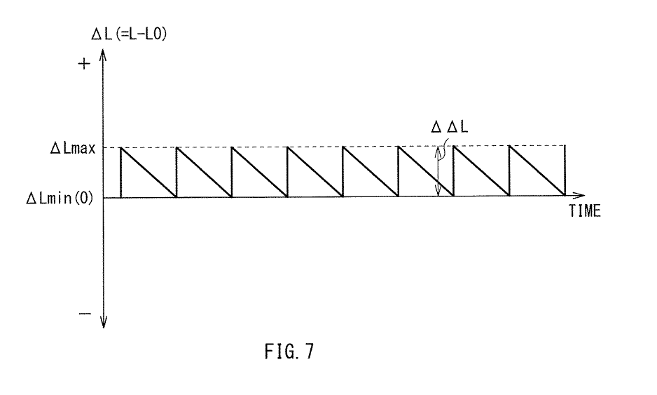

FIG. 7 illustrates an example of variation with time in the optical path length error ΔL in the MOPO 40A illustrated in FIG. 6 in a case in which the optical path length error ΔL in the optical resonator of the PO 60 is corrected. In the present embodiment, in the optical resonator of the PO 60, the seed light 51 may be amplified in the form of pulse while the minimum value ΔLmin of the optical path length error ΔL approaches zero; as illustrated in FIG. 7

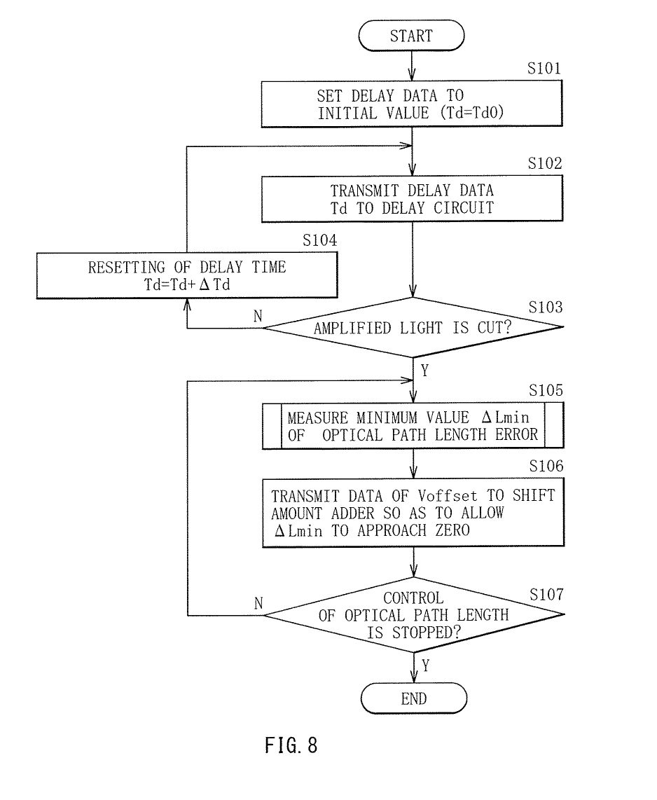

FIG. 8 schematically illustrates an example of a flow of control of the optical path length in the optical resonator in the narrow-band titanium-sapphire laser apparatus 20 illustrated in FIG. 6.

The error controller 55 may set the delay data Id to initial delay data Td=Td0 (step S101). Subsequently, the delay data Td may be transmitted to the delay circuit 57 (step S102). Thereafter, the error controller 55 may determine whether amplified light of the seed light 51 is cut by the first optical shutter 53A so as not to allow the amplified light to enter the optical path length error detector 43 (step S103). When the error controller 55 determines that the amplified light is not cut (step S103; N), the error controller 55 may perform resetting of the delay time (step S104) and may return to a process in the step S102. It is to be noted that the delay time may be reset to Td=Td+ΔTd. In other words, the reset value may result from adding a predetermined time ΔTd to the delay data Td before being reset.

In contrast, when the error controller 55 determines that the amplified light is cut (step S103; Y), the error controller 55 may then measure the minimum value ΔLmin of the optical path length error ΔL (step S105). Subsequently, the error controller 55 may transmit data of the correction value Voffset to the shift amount adder 54 so as to allow the minimum value ΔLmin of the optical path length error ΔL to approach zero (step S106). Thereafter, the error controller 55 may determine whether the control of the optical path length is stopped (step S107). When the control of the optical path length is not stopped (step S107; N), the error controller 55 may return to a process in the step S105. When the control of the optical path length is stopped (step S107; Y), the error controller 55 may end the process.

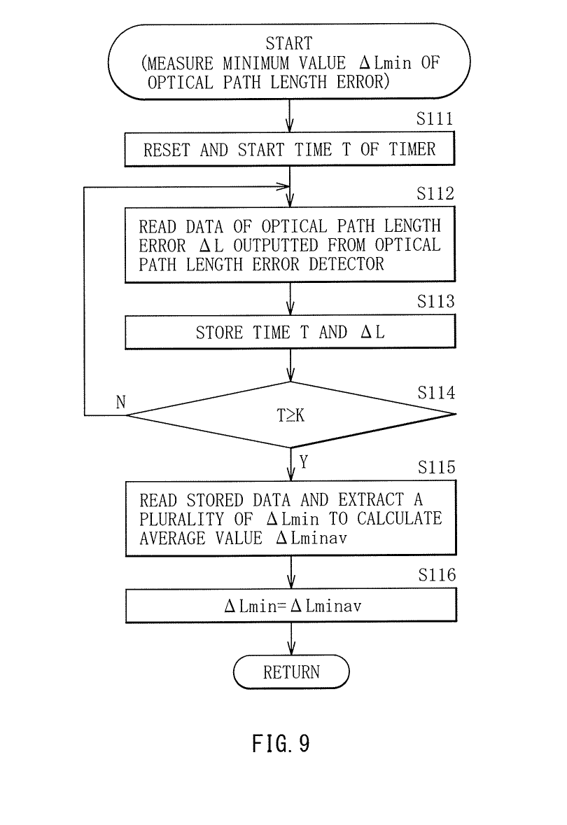

FIG. 9 is a sub-flow chart illustrating details of the process in the step S105.

The error controller 55 may reset a time T of an unillustrated timer and start the time T (step S111). Subsequently, the error controller 55 may read data of the optical path length error ΔL outputted from the optical path length error detector 43 (step S112). Next, the error controller 55 may store data of the time T and data of the optical path length error ΔL (step S113). Thereafter, the error controller 55 may determine whether or not the time T is equal to or longer than a predetermined time K, i.e., T≧K (step S114). When the error controller 55 determines that the time T is not equal to or longer than the predetermined time K (step S114; N), the error controller 55 may return to a process in the step S112. In contrast, when the error controller 55 determines that the time T is equal to or longer than the predetermined time K (step S104; Y), the error controller 55 may read stored data and extract data of a plurality of minimum values ΔLmin to calculate an average value ΔLminav (step S115).

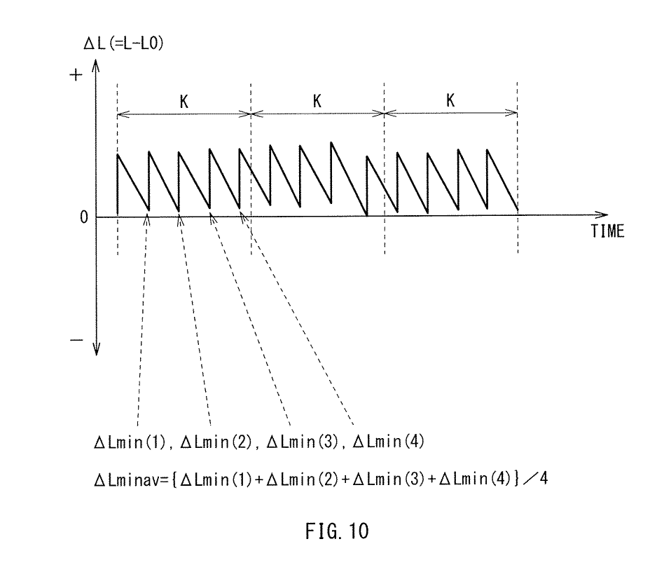

Here, FIG. 10 schematically illustrates an example of a method of measuring the minimum value ΔLmin of the optical path length error ΔL. A horizontal axis and a vertical axis in FIG. 10 may indicate time and the optical path length error ΔL, respectively. For example, minimum values ΔLmin(1), ΔLmin(2), ΔLmin(3), and ΔLmin(4) may be detected as data of the minimum value ΔLmin of the optical path length error ΔL in the predetermined time K, as illustrated in FIG. 10. In this case, the error controller 55 may calculate the average value ΔLminav of the minimum values ΔLmin as follows.

ΔLminav={ΔLmin(1)+ΔLmin(2)+ΔLmin(3)+ΔLmin(4)}/4

Next, the error controller 55 may use the determined average value ΔLminav as the minimum value ΔLmin of the optical path length error ΔL (step S116), and thereafter may return to the main flow in FIG. 8.

### (3.1.3 Effect)

According to the MOPO 40A in the present embodiment, control is performed so as to allow the minimum value ΔLmin of the optical path length error ΔL to approach zero immediately before the seed light 51 is amplified in the form of pulse in the optical resonator of the PO 60. This makes it possible to enhance efficiency of pulse amplification of the seed light 51. This also makes it possible to stabilize an output timing and a pulse waveform of the seed light 51 amplified in the form of pulse.

### (3.2 Multipass Amplifier Unit)

(3.2.1 Configuration)

FIG. 11 schematically illustrates a configuration example of the multipass titanium-sapphire amplifier in the multipass amplifier unit 41 as a configuration of a main part of the narrow-band titanium-sapphire laser apparatus 20 according to the first embodiment of the present disclosure. FIG. 12 schematically illustrates an optically equivalent diagram of a multipass optical system in the multipass titanium-sapphire amplifier illustrated in FIG. 11.

FIG. 11 collectively illustrates configurations of the first multipass titanium-sapphire amplifier 73A and the second multipass titanium-sapphire amplifier 73B.

The first multipass titanium-sapphire amplifier 73A may include a multipass optical system 80 as a first multipass optical system. The second multipass titanium-sapphire amplifier 73B may include the multipass optical system 80 as a second multipass optical system. The multipass optical system 80 may include an input mirror 81 and an output mirror 82. The multipass optical system 80 may further include a condenser lens 84, a dichroic mirror 85, a dichroic mirror 86, a condenser lens 87, and turning back mirrors 88A and 88B.

The first multipass titanium-sapphire amplifier 73A may include a first multiple optical path 75A configured by the multipass optical system 80 and the first titanium-sapphire crystal 74A provided in the first multiple optical path 75A. The seed light 51 amplified by the PO 60 may pass through components such as the fourth high reflection mirror 104 to be inputted to the first multipass titanium-sapphire amplifier 73A via the input mirror 81.

The second multipass titanium-sapphire amplifier 73B may include a second multiple optical path 75B configured by the multipass optical system 80 and the second titanium-sapphire crystal 74B provided in the second multiple optical path 75B. The seed light 51 amplified by the first multipass titanium-sapphire amplifier 73A may pass through the eighth high reflection mirror 108 and the ninth high reflection mirror 109 to be inputted to the second multipass titanium-sapphire amplifier 73B via the input mirror 81.

In the first multipass titanium-sapphire amplifier 73A, the second condenser lens 72B may be provided so as to allow the second pulsed laser light 71B to be condensed on the first titanium-sapphire crystal 74A via the dichroic mirror 86. The second pulsed laser light 71B may be excitation light that is used for amplification and is outputted from the second excitation pulsed laser unit 70B. In the first multipass titanium-sapphire amplifier 73A, the dichroic mirror 85 and the dichroic mirror 86 may be provided so as to allow the seed light 51 to reciprocate through the first titanium-sapphire crystal 74A. In the first multipass titanium-sapphire amplifier 73A, the output mirror 82 may be provided so as to allow the seed light 51 having reciprocated through the first titanium-sapphire crystal 74A to be outputted toward the eighth high reflection mirror 108.

In the second multipass titanium-sapphire amplifier 73B, the third condenser lens 72C may be provided so as to allow the third pulsed laser light 71C to be condensed on the second titanium-sapphire crystal 74B via the dichroic mirror 86. The third pulsed laser light 71C may be excitation light that is used for amplification and is outputted from the third excitation pulsed laser unit 70C. In the second multipass titanium-sapphire amplifier 73B, the dichroic mirror 85 and the dichroic mirror 86 may be provided so as to allow the seed light 51 to reciprocate through the second titanium-sapphire crystal 74B. In the second multipass titanium-sapphire amplifier 73B, the output mirror 82 may be provided so as to allo the seed light 51 having reciprocated through the second titanium-sapphire crystal 74B to be outputted toward the tenth high reflection mirror 10.

A focal length f1 of the condenser lens 84 and a focal length f2 of the condenser lens 87 each may be substantially equal to a predetermined focal length f. The condenser lens 84 and the condenser lens 87 may be provided so as to have a focal length substantially equal to the predetermined focal length f and so as to allow an optical path length between the condenser lens 84 and the condenser lens 87 to be substantially twice the predetermined focal length f, as illustrated in FIG. 12. The first titanium-sapphire crystal 74A and the second titanium-sapphire crystal 74B each may be provided in an optical path at a substantially middle point between the condenser lens 84 and the condenser lens 87.

The dichroic mirror 85 may be provided in an optical path between the condenser lens 84 and one of the first titanium-sapphire crystal 74A and the second titanium-sapphire crystal 74B so as to reflect the seed light 51 at substantially 45 degrees. A surface of the dichroic mirror 85 may be coated with a film that allows excitation light to pass therethrough at high transmittance and reflects the seed light 51 at high reflectivity.

The dichroic mirror 86 may be provided in an optical path between the condenser lens 87 and the one of the first titanium-sapphire crystal 74A and the second titanium-sapphire crystal 74B so as to reflect the seed light 51 at substantially 45 degrees. A surface of the dichroic mirror 86 may be coated with a film that allows excitation light to pass therethrough at high transmittance and reflects the seed light 51 at high reflectivity.

The input mirror 81 may be provided to allow the seed light 51 to pass through substantially a center of the condenser lens 84. The turning back mirrors 88A and 88B may configure a pair of turning back mirrors, and may be provided so as to turn back, to the condenser lens 87, the seed light 51 having entered the pair of turning back mirrors via the condenser lens 87. The turning back mirrors 88A and 88B may be provided so as to allow an optical path length of an optical path from the condenser lens 87 via the turning back mirrors 88A and 88B to the condenser lens 87 to be substantially twice the predetermined focal length f.

### (3.2.2 Operation)

The seed light 51 having entered the multipass optical system 80 may be reflected by the input mirror 81 to enter substantially the center of the condenser lens 84 through a front-side focal position of the condenser lens 84. An incident beam position PO where an incident beam image Im0 of the seed light 51 is formed may be substantially the same as the front-side focal position of the condenser lens 84, as illustrated in FIG. 12. Thereafter, the seed light 51 may pass through one of the first titanium-sapphire crystal 74A and the second titanium-sapphire crystal 74B via the dichroic mirror 85 to be amplified.

The amplified seed light 51 may be reflected by the turning back mirror 88A provided at a predetermined entry position via the dichroic mirror 86 and the condenser lens 87 to pass through a first transfer position P1, and thereafter may be reflected by the turning back mirror 88B to enter the condenser lens 87 again. A first transfer image Im1 of the incident beam image IM0 may be transferred and formed at the first transfer position P1, as illustrated in FIG. 12. Thereafter, the seed light 51 may pass through the one of the first titanium-sapphire crystal 74A and the second titanium-sapphire crystal 74B via the dichroic mirror 86 again to be further amplified. The amplified seed light 51 may be reflected by the output mirror 82 via the diachronic mirror 85 and the condenser lens 84 to be outputted through a second transfer position P2. A second transfer image Im2 of the incident beam image Im0 may be transferred and formed at the second transfer position P2.

As described above, the multipass optical system 80 may allow the seed light 51 to reciprocate through one of the first titanium-sapphire crystal 74A and the second titanium-sapphire crystal 74B. At this occasion, the first transfer image Im1 of the incident beam image Im0 may be transferred and formed at the first transfer position P1. Moreover, the second transfer image Im2 of the incident beam image Im0 may be transferred and formed at the second transfer position P2.

Here, in a comparison between a beam profile of the first transfer image Im1 and a beam profile of the second transfer image Im2, the beam profile of the first transfer image Im1 may be deteriorated, whereas deterioration of the beam profile of the second transfer image Im2 may be suppressed.

### (3.2.3 Effect)

As described above, according to the multipass amplifier unit 41 in the present embodiment, while the multipass optical system 80 allows the incident beam image Im0 to be transferred and formed an even number of times, the seed light 51 may reciprocate through one of the first titanium-sapphire crystal 74A and the second titanium-sapphire crystal 74B to be amplified. Accordingly, distortion of a beam of amplified light by the thermal lens effect may be suppressed.

### (3.2.4 Modification Examples)

The above description involves an example in a case in which the focal length f1 of the condenser lens 84 and the focal length f2 of the condenser lens 87 each are substantially equal to the predetermined focal length f; however, the present embodiment is not limited to the example. The focal lengths f1 and F2 may be different from each other. Even in this case, a multipass optical system that allows the incident beam image Im0 to reciprocate through one of the first titanium-sapphire crystal 74A and the second titanium-sapphire crystal 74B a plurality of times while the incident beam image Im0 is transferred and formed a plurality of times may be configured. In a case in which the focal length f1 of the condenser lens 84 and the focal length f2 of the condenser lens 87 are different from each other, for example, the condenser lens 84 and the condenser lens 87 may be provided so as to allow a rear-side focal position of the condenser lens 84 to be substantially coincident with a front-side focal position of the condenser lens 87, as illustrated in FIG. 12. At this occasion, the optical path length between the condenser lens 84 and the condenser lens 87 may be substantially equal to a sum (f1+f2) of the focal length f1 of the condenser lens 84 and the focal length f2 of the condenser lens 87. Moreover, the turning back mirrors 88A and 88B may be provided so as to allow the optical path length of the optical path from the condenser lens 87 via the turning back mirrors 88A and 88B to the condenser lens 87 to be substantially twice the focal length 12 of the condenser lens 87.

Moreover, in the first and second multipass titanium-sapphire amplifiers 73A and 73B, the number of reciprocations of the seed light 51 is not limited to one reciprocation illustrated in FIG. 11. A multipass optical system that allows the incident beam image Im0 to reciprocate one of the first titanium-sapphire crystal 74A and the second titanium-sapphire crystal 74B a plurality of times while the incident beam image Im0 is transferred and formed a plurality of times may be adopted. Further, the number of reciprocations of the seed light 51 may differ for first multipass titanium-sapphire amplifier 73A and the second multipass titanium-sapphire amplifier 73B. Furthermore, the number of reciprocations of the seed light 51 in the second multipass titanium-sapphire amplifier 73B may be equal to or smaller than the number of reciprocations of the seed light 51 in the first multipass titanium-sapphire amplifier 73A.

Hereinafter, an example in which three reciprocations of the seed light 51 are performed is described as a modification example of the foregoing embodiment. It is to be noted that in the following modification example, substantially same components as the components of the foregoing multipass optical system 80 illustrated in FIGS. 11 and 12 are denoted by same reference numerals, and redundant description thereof is omitted.

### 3.2.4.1 First Modification Example

FIG. 13 illustrates a first modification example of the multipass titanium-sapphire amplifier illustrated in FIG. 11. FIG. 13 collectively illustrates configurations of the first multipass titanium-sapphire amplifier 73A and the second multipass titanium-sapphire amplifier 73B.

### (Configuration)

The first multipass titanium-sapphire amplifier 73A may include a multipass optical system 80A as the first multipass optical system, in place of the foregoing multipass optical system 80 illustrated in FIGS. 11 and 12. The second multipass titanium-sapphire amplifier 73B may include the multipass optical system 80A as the second multipass optical system, in place of the foregoing multipass optical system 80 illustrated in FIGS. 11 and 12.

The multipass optical system 80A may include turning back mirrors 83A and 83B, turning back mirrors 83C and 83D, the turning back mirrors 88A and 88B, turning back mirrors 88C and 881), and turning back mirrors 88E and 88F.

The turning back mirrors 88A and 88B may configure a pair of turning back mirrors, and may be provided so as to turn back, to the condenser lens 87, the seed light 51 having entered the turning back mirrors 88A and 88B via the condenser lens 87. The turning back mirrors 88A and 88B may be provided so as to allow an optical path length of an optical path from the condenser lens 87 via the turning back mirrors 88A and 88B to the condenser lens 87 to be substantially twice the predetermined focal length f.

The turning back mirrors 83A and 83B may configure a pair of turning back mirrors, and may be provided so as to turn back, to the condense lens 84, the seed light 51 having entered the turning back mirrors 83A and 83B via the condenser lens 84. The turning back mirrors 83A and 83B may be provided so as to allow an optical path length of an optical path from the condenser lens 84 via the turning back mirrors 83A and 83B to the condenser lens 84 to be substantially twice the predetermined focal length f.

The turning back mirrors 88C and 88D may configure a pair of turning back mirrors, and may be provided so as to turn back, to the condenser lens 87, the seed light having entered the turning back mirrors 88C and 88D via the condenser lens 87. The turning back mirrors 88C and 88D may be provided so as to allow an optical path length of an optical path from the condenser lens 87 via the turning back mirrors 88C and 88D to the condenser lens 87 to be substantially twice the predetermined focal length f.

The turning back mirrors 83C and 83D may configure a pair of turning back mirrors, and may be provided so as to turn back, to the condenser lens 84, the seed light having entered the turning back mirrors 83C and 83D via the condenser lens 84. The turning back mirrors 83C and 83D may be provided so as to allow an optical path length of an optical path from the condenser lens 84 via the turning back mirrors 83C and 83D to the condenser lens 84 to be substantially twice the predetermined focal length f.

The turning back mirrors 88E and 88F may configure a pair of turning back mirrors, and may be provided so as to turn back, to the condenser lens 87, the seed light having entered the turning back mirrors 88E and 88F via the condenser lens 87. The turning back mirrors 88E and 88F may be provided so as to allow an optical path length of an optical path from the condenser lens 87 via the turning back mirrors 88E and 88F to the condenser lens 87 to be substantially twice the predetermined focal length f.

### (Operation)

The seed light 51 having entered the multipass optical system 80A may be reflected by the input mirror 81 to enter substantially the center of the condenser lens 84 through the front-side focal position of the condenser lens 84 that is the predetermined entry position. At this occasion, as with the embodiment in FIG. 12, the incident beam position PO where the incident beam image Im0 of the seed light 51 is formed may be substantially the same as the front-side focal position of the condenser lens 84. Thereafter, the seed light 51 may pass through one of the first titanium-sapphire crystal 74A and the second titanium-sapphire crystal 74B via the dichroic mirror 85 to be amplified.

The amplified seed light 51 may be reflected by the turning back mirror 88A via the dichroic mirror 86 and the condenser lens 87 to pass through the first transfer position P1, and thereafter may be reflected by the turning back mirror 88B to enter the condenser lens 87 again. The transfer image Im1 of the incident beam image Im0 may be transferred and formed at the first transfer position P1. Thereafter, the seed light 51 may pass through the one of the first titanium-sapphire crystal 74A and the second titanium-sapphire crystal 74B via the dichroic mirror 86 again to be further amplified.

The amplified seed light 51 may be reflected by the turning back mirror 83A via the dichroic mirror 85 and the condenser lens 84 to pass through the second transfer position P2, and thereafter may be reflected by the turning back mirror 83B to enter the condenser lens 84 again. The second transfer image Im2 of the incident beam image Im0 may be transferred and formed at the second transfer position P2. Thereafter, the seed light 51 may pass through the one of the first titanium-sapphire crystal 74A and the second titanium-sapphire crystal 74B via the dichroic mirror 85 again to be further amplified.

The amplified seed light 51 may be reflected by the turning back mirror 88C via the dichroic mirror 86 and the condenser lens 87 to pass through a third transfer position P3, and thereafter may be reflected by the turning back mirror 88D to enter the condenser lens 87 again. A third transfer image Im3 of the incident beam image Im0 may be transferred and formed at the third transfer position P3. Thereafter, the seed light 51 may pass through the one of the first titanium-sapphire crystal 74A and the second titanium-sapphire crystal 74B via the dichroic mirror 86 again to be further amplified,

The amplified seed light 51 may be reflected by the turning back mirror 83C via the dichroic mirror 85 and the condenser lens 84 to pass through a fourth transfer position P4, and thereafter may be reflected by the turning back mirror 83D to enter the condenser lens 84 again. A fourth transfer image Im4 of the incident beam image Im0 may be transferred and formed at the fourth transfer position P4. Thereafter, the seed light 51 may pass through the one of the first titanium-sapphire crystal 74A and the second titanium-sapphire crystal 74B via the dichroic mirror 85 again to be further amplified.

The amplified seed light 51 may be reflected by the turning back mirror 88E via the dichroic mirror 86 and the condenser lens 87 to pass through a fifth transfer position P5, and thereafter may be reflected by the turning back mirror 88E to enter the condenser lens 87 again. A fifth transfer image Im5 of the incident beam image Im0 may be transferred and formed at the fifth transfer position P5. Thereafter, the seed light 51 may pass through the one of the first titanium-sapphire crystal 74A and the second titanium-sapphire crystal 74B via the dichroic mirror 86 again to be further amplified.

The amplified seed light 51 may be reflected by the output mirror 82 via the dichroic mirror 85 and the condenser lens 84 to be outputted through a sixth transfer position P6. A sixth transfer image Im6 of the incident beam image Im0 may be transferred and formed at the sixth transfer position P6.

As described above, in the multipass optical system 80A, the seed light 51 may reciprocate through one of the first titanium-sapphire crystal 74A and the second titanium-sapphire crystal 74B. At this occasion, the incident beam image Im0 may be transferred and formed six times in total as first to sixth transfer images. Here, beam profiles of the first, third, and fifth transfer images out of the first to sixth transfer images may be deteriorated, whereas deterioration of beam profiles of the second, fourth, and sixth transfer images may be suppressed.

### (Effect)

As described above, while the multipass optical system 80A allows the incident beam image Im0 to be transferred and formed an even number of times, the seed light 51 may reciprocate through one of the first titanium-sapphire crystal 74A and the second titanium-sapphire crystal 74B to be amplified. Accordingly, distortion of a beam of amplified light by the thermal lens effect may be suppressed.

### 3.2.4.2 Second Modification Example

FIG. 14 illustrates a second modification example of the multipass titanium-sapphire amplifier illustrated in FIG. 11. FIG. 14 collectively illustrates configurations of the first multipass titanium-sapphire amplifier 73A and the second multipass titanium-sapphire amplifier 73B.

The first and second multipass titanium-sapphire amplifiers 73A and 73B each may include a multipass optical system 8013 in place of the foregoing multipass optical system 80A illustrated in FIG. 13. The multipass optical system 8013 may include dispersing prisms 89A and 89B.

A gain is small in a wavelength region of a wavelength of 904 nm, which easily causes amplified spontaneous emission (ASE). In order to suppress ASE, the dispersing prisms 89A and 89B may be inserted in an optical path in each of the first and second titanium-sapphire amplifiers 73A and 73B, as illustrated in FIG. 14. Alternatively, only one of the dispersing prisms 89A and 89B may be inserted. The dispersing prism 89A may be provided between the condenser lens 84 and both the turning back mirrors 83A and 83C. The dispersing prism 89B may be provided between the condenser lens 87 and both the turning back mirrors 88C and 88E,

### 4. Second Embodiment

Next, description is given of a titanium-sapphire laser apparatus and a laser apparatus used for an exposure apparatus according to a second embodiment of the present disclosure. Note that substantially same components as the components of the titanium-sapphire laser apparatus and the laser apparatus used for the exposure apparatus according to the foregoing comparative example or the foregoing first embodiment are denoted by same reference numerals, and redundant description thereof is omitted.

A basic configuration of the laser apparatus used for the exposure apparatus according to the present embodiment may be substantially similar to that of the laser apparatus used for the exposure apparatus illustrated in FIG. 1.

### (4.1 MOPO)

(4.1.1 Configuration)

FIG. 15 schematically illustrates a configuration example of an MOPO 40B as a configuration of a main part of the narrow-band titanium-sapphire laser apparatus 20 according to the second embodiment of the present disclosure.

The narrow-band titanium-sapphire laser apparatus 20 according to the present embodiment may include the MOPO 40B including a band pass filter 58, in place of the MOPO 40A in the configuration of the foregoing first embodiment illustrated in FIG. 6. The narrow-band titanium-sapphire laser apparatus 20 according to the present embodiment may further include a second optical shutter 53B in addition to the configuration of the foregoing first embodiment illustrated in FIG. 6.

The band pass filter 58 may be provided in an optical path in the optical resonator of the PO 60. The band pass filter 58 may allow light in a wavelength region around a wavelength of 904 nm that is the wavelength of the seed light 51 to selectively pass therethrough.

The second optical shutter 53B may be provided in an optical path between the PO 60 and the multipass amplifier unit 41. The delay circuit 57 may receive an oscillation trigger of the synchronous circuit 13 and may output a signal for control of opening and closing of the second optical shutter 54B after a predetermined delay time.

### (4.1.2 Effect)

According to the MOPO 40B in the present embodiment, the band pass filter 58 is provided in the optical path in the optical resonator of the PO 60, which makes it possible to suppress oscillation of a wavelength component other than the seed light 51. A gain is small wavelength region of a wavelength of 904 nm, which easily causes oscillation of laser light of the wavelength component other than the seed light 51. Accordingly, providing the band pass filter 58 that allows light in a wavelength region of the seed light 51 to pass therethrough at high transmittance makes it possible to suppress oscillation of the wavelength component other than the seed light 51. This makes it possible for the PO 60 to amplify and oscillate even weak CW seed light Si to produce laser light of the same wavelength as that of a laser diode.

Moreover, according to the narrow-band titanium-sapphire laser apparatus 20 in the present embodiment, the second optical shutter 53B is provided between the PO 60 and the multipass amplifier unit 41, which makes it possible to suppress variation in a pulsed width of the seed light 51 amplified in the form of pulse after having passed through the second optical shutter 53B and fluctuation of a pulse rising time of the amplified seed light 51. In an injection locking method for the PO 60, the pulse rising time and a pulse waveform may vary to some extent by a slight optical path length error in the optical resonator. In other words, even if the pulse of the seed light 51 entering the second optical shutter 53B varies to some extent, trimming the pulse of the seed light 51 by the second optical shutter 53B makes it possible to stabilize the pulse rising time and the pulse waveform of the seed light 51 outputted from the second optical shutter 53B. Moreover, when the optical resonator is designed suitably for a thermal lens of the titanium-sapphire crystal 61 of the PO 60, the optical path length in the optical resonator may increase. Therefore, the second optical shutter 53B that operates at high speed may be introduced to perform opening and closing at predetermined timings, thereby trimming the seed light 51 amplified in the form of pulse. This makes it possible to suppress variation in the pulse width and fluctuation of the pulse rising time. Since final output from the narrow-band titanium-sapphire laser apparatus 20 is determined by the multipass amplifier unit 41, it is possible to reduce an influence of loss due to trimming by the second optical shutter 53B.

### (4.2 Multipass Amplifier Unit)

### 4.2.1 Configuration

FIG. 16 schematically illustrates a configuration example of a multipass amplifier unit 41A as a configuration of a main part of the narrow-band titanium-sapphire laser apparatus 20 according to the second embodiment of the present disclosure.

The narrow-band titanium-sapphire laser apparatus 20 according to the present embodiment may include the multipass amplifier unit 41A in place of the multipass amplifier unit 41 in the configuration of the comparative example illustrated in FIG. 2. The multipass amplifier unit 41A may include a third multipass titanium-sapphire amplifier 73C. The third multipass titanium-sapphire amplifier 73C may include a third titanium-sapphire crystal that is different from the titanium-sapphire crystal 61. The third multipass titanium-sapphire amplifier 73C may be configured to allow the seed light 51 to reciprocate through the third titanium-sapphire crystal in a manner substantially similar to that in the first and second multipass titanium-sapphire amplifiers 73A and 73B illustrated in FIG. 11.

The multipass amplifier unit 41A may further include a fourth excitation pulsed laser unit 70D, a fourth condenser lens 72D, an eleventh high reflection mirror 111, and a twelfth high reflection mirror 112. The fourth excitation pulsed laser unit 70D may be a pulsed laser unit that outputs fourth pulsed laser light 71D used for excitation.

An oscillation trigger may be inputted from the synchronous circuit 13 to each of the first, second, and third excitation pulsed laser units 70A, 70B, and 70C and the fourth excitation pulsed laser unit 70D,

### 4.2.2 Operation and Effect

In the multipass amplifier unit 41A, the seed light 51 amplified by the second multipass titanium-sapphire amplifier 73B may enter the third multipass titanium-sapphire amplifier 73C via the tenth high reflection mirror 110 and the eleventh high reflection mirror 111. In the third multipass titanium-sapphire amplifier 73C, the seed light 51 of a wavelength of 904 nm amplified in the form of pulse may enter the third titanium-sapphire crystal. The fourth pulsed laser light 71D serving as excitation light from the fourth excitation pulsed laser unit 70D may enter the third titanium-sapphire crystal in synchronization with an entry timing of the seed light 51 to excite the seed light 51 in the form of pulse. In the third multipass titanium-sapphire amplifier 73C, multiple passing of pulsed laser light of a wavelength of 904 nm through the third titanium-sapphire crystal may amplify the seed light 51 a plurality of times.

The seed light 51 amplified by the third multipass titanium-sapphire amplifier 73C may enter the LBO crystal 1 via the twelfth high reflection mirror 112.

At this occasion, the multipass amplifier unit 41A for further amplification of the seed light 51 of a wavelength of 904 nm amplified in the form of pulse has a small amplification gain at this wavelength. In order to have a sufficiently long focal length of the thermal lens in the titanium-sapphire crystal with respect to a crystal length, it is necessary to optimize the number of times of multiple passing in the multipass amplifier unit 41A and the number of multipass titanium-sapphire amplifiers.

In the multipass amplifier unit 41A in the present embodiment, the number of times of multiple passing in the first multipass titanium-sapphire amplifier 73A may be three reciprocations. Moreover, the number of times of multiple passing in the second multipass titanium-sapphire amplifier 73B may be two reciprocations. Further, the number of times of multiple passing in the third multipass titanium-sapphire amplifier 73C may be one reciprocation.

Incidentally, as illustrated in FIG. 5 mentioned above, as input of the excitation light increases, the focal length by the thermal lens effect in the titanium-sapphire crystal may be shortened. When the focal length of the thermal lens by the thermal lens effect is about 10 mm or less, even if a position of an optical device of an optical system for multiple passing through the titanium-sapphire crystal is adjusted in an optical path axis direction, deterioration in beam characteristics after amplification may not suppressed. Examples of the optical device may include the condenser lenses 84 and 87 illustrated in FIG. 11. In particular, when the number of reciprocations increases, deterioration in beam characteristics may be pronounced by the thermal lens effect in the titanium-sapphire crystal.

FIG. 17 illustrates an example of amplification characteristics of the multipass amplifier unit 41A illustrated in FIG. 16.

An upper portion of FIG. 17 illustrates a relationship between the total number of reciprocations of the seed light 51 in the first, second, and third multipass titanium-sapphire amplifiers 73A, 73B, and 73C and pulse energy of amplified light of the seed light 51. As illustrated in the upper portion of FIG. 17, in the first multipass titanium-sapphire amplifier 73A, first amplified light of the seed light 51 having small pulse energy outputted from the PO 60 may reciprocate three times to be amplified until a gain is saturated, and the thus-amplified seed light 51 may be outputted as second amplified light.

In the second multipass titanium-sapphire amplifier 73B, the second amplified light of the seed light 51 may reciprocate twice to be amplified until a gain is saturated, and the thus-amplified light may be outputted as third amplified light.

In the third multipass titanium-sapphire amplifier 73C, the third amplified light of the seed light 51 may reciprocate once to be amplified until a gain is saturated, and the thus-amplified light may be outputted as fourth amplified light.

A lower portion of FIG. 17 illustrates a relationship between the total number of reciprocations of the seed light 51 in the first, second, and third multipass titanium-sapphire amplifiers 73A, 73B, and 73C and M² of amplified light of the seed light 51, where M² may indicate light condensing performance of laser beam characteristics. M²=1 may indicate single transverse mode laser beam condensing performance. It may be indicated that the condensing performance of laser light deteriorates as M² that is larger than 1 increases.

In the first, second, and third multipass titanium-sapphire amplifiers 73A, 73B, and 73C, M² may increase in an odd number of times of multiple passing, and M² may be improved by an even number of times of multiple passing. Performing the even number of times of multiple passing may mean multiple passing so as to cause reciprocation through the titanium-sapphire crystal. Energy of excitation light of each of the first, second, and third multipass titanium-sapphire amplifiers 73A, 73B, and 73C may have the following relationship of input of excitation light in order to sequentially increase a gain to be saturated.

(Input of excitation light to the first multipass titanium-sapphire amplifier 73A)<(input of excitation light to the second multipass titanium-sapphire amplifier 73B)<(input of excitation light to the third multipass titanium-sapphire amplifier 73C)

The more the input of the excitation light increases, the more M² of the amplified light after one reciprocation may increase, as illustrated in the lower portion of FIG. 17.

As described above, in terms of a relationship between saturation of the gain and an increase in M², the number of reciprocations in first multipass titanium-sapphire amplifier 73A may be three. The number of reciprocations in the second multipass titanium-sapphire amplifier 73B may be two. The number of reciprocations in the third multipass titanium-sapphire amplifier 73C may be one. This makes it possible to improve amplification efficiency and to suppress an increase in M².

### 4.2.3 Modification Example

FIG. 18 schematically illustrates a configuration example of a multipass amplifier unit 41B according to a modification example of the present embodiment. A dispersing prism 59 may be provided in an optical path between the first multipass titanium-sapphire amplifier 73A and the second multipass titanium-sapphire amplifier 73B, as with the multipass amplifier unit 41B illustrated in FIG. 18. The dispersing prism 59 makes it possible to suppress entry of ASE light generated in the first titanium-sapphire crystal 74A of the first multipass titanium-sapphire amplifier 73A into the second multipass titanium-sapphire amplifier 73B.

### (Another Configuration)

In the modification example in FIG. 18, the dispersing prism 59 may be provided in the optical path between the first multipass titanium-sapphire amplifier 73A and the second multipass titanium-sapphire amplifier 73B. Alternatively, the dispersing prism 59 may be provided in an optical path of the seed light 51 other than the foregoing optical path, as necessary. This makes it possible to suppress ASE of a wavelength other than a wavelength around 904 nm and to suppress deterioration in beam characteristics of amplified pulsed laser light by the thermal lens effect.

### 5. Configuration Example of Optical Path Length Error Detector

Next, description is given of a specific configuration example of the optical path length error detector 43 with reference to FIG. 19. Note that substantially same components as the components of the titanium-sapphire laser apparatus and the laser apparatus used for the exposure apparatus according to any of the foregoing comparative example and the foregoing first and second embodiments are denoted by same reference numerals, and redundant description thereof is omitted.

### 5.1 Configuration

The optical path length error detector 43 may be a detector by a Hansch-Couillaud method. The Hansch-Couillaud method may be a method of detecting the optical path length error ΔL between a positive integer multiple of the wavelength of the seed light 51 and the optical path length in the optical resonator by measuring polarization characteristics of the leak light 52 of the seed light 51 from the optical resonator.

The optical path length error detector 43 may include a λ/2 plate 91, a λ/4 plate 92, a polarizer 93, a high reflection mirror 94, a first optical sensor 95A, a second optical sensor 95B, and a subtracter 96.

### 5.2 Operation

In order to analyze a polarization state of the leak light 52, the leak light 52 may pass through the λ/2 plate 91 and the λ/4 plate 92, and may be separated by the polarizer 93 into a P-polarized component and an S-polarized component Thereafter, light intensities of the respective polarized components may be detected by the first optical sensor 95A and the second optical sensor 95B.

The subtractor 96 may subtract signals of light intensity of the first optical sensor 95A and the second optical sensor 95B from each other, and when a value of the subtractor 96 is zero, the positive integer multiple of the wavelength of the seed light 51 may be equal to the optical path length in the optical resonator. A subtracted voltage value may be outputted from the subtractor 96 in accordance with the optical path length error ΔL. The voltage value outputted from the substractor 96 may be read by the error controller 55 to measure a state of the optical path length error ΔL.

### 5.3 Modification Examples

In the configuration example in FIG. 19, the method of measuring the optical path length error ΔL is the Hansch-Couillaud method, but is not limited thereto. Alternatively, any other method such as a Pound-Derever-Hall method and a phase sensitive detection method may be adopted.

### 6. Configuration Example of Optical Shutter

Next, description is given of a specific configuration example of an optical shutter 310 applicable as the first optical shutter 53A and the second optical shutter 53B mentioned above with reference to FIG. 20. It is to be noted that substantially same components as the components of the titanium-sapphire laser apparatus and the laser apparatus used for the exposure apparatus according to any of the foregoing comparative example and the foregoing first and second embodiments are denoted by same reference numerals, and redundant description thereof is omitted.

### (6.1 Configuration)

FIG. 20 illustrates a configuration example of the optical shutter 310. The optical shutter 310 may include a Pockets cell 394 and a polarizer 396. The pockets cell 394 may include a high-voltage power source 393, a first electrode 395a, a second electrode 395b, and an electro-optic crystal 395c. The first electrode 395a and the second electrode 395b may be provided to face each other, and the electro-optic crystal 395c may be provided between the first electrode 395a and the second electrode 395b. The high-voltage power source 393 may be controlled by a transmittance setter 311 and a synchronous circuit 312.

### (6.2 Operation)

The high-voltage power source 393 may receive a control signal of the optical shutter 310 from the transmittance setter 311 or the synchronous circuit 312. The high-voltage power source 393 may generate a predetermined high voltage that is not 0 V upon reception of an open signal as the control signal of the optical shutter 310, and may apply the generated voltage between the first electrode 395a and the second electrode 395b. The open signal r ray allow the optical shutter 310 to be opened. The high-voltage power source 393 may change the voltage to be applied between the first electrode 395a and the second electrode 39b to 0 V upon reception of a close signal as the control signal of the optical shutter 310. The close signal may allow the optical shutter to be closed.

The Pockets cell 394 may have a function equivalent to a λ/2 plate when a predetermined high voltage is applied between the first electrode 395a and the second electrode 395b. When the predetermined high voltage is not applied between the first electrode 395a and the second electrode 395b, light linearly polarized in a direction perpendicular to a paper plane may pass through the electro-optic crystal 39c without changing its polarization state, and may be reflected by the polarizer 396. In FIG. 20, light linearly polarized in the direction perpendicular to the paper plane may be indicated by a black circle drawn in a laser optical path. At this occasion, upon application of the predetermined high voltage, a phase of the light linearly polarized in the direction perpendicular to the paper plane may be shifted by 212 to cause the light linearly polarized in the direction perpendicular to the paper plane to be converted into light linearly polarized in a direction including the paper plane. In FIG. 20, the light linearly polarized in the direction including the paper plane may be indicated by an arrow perpendicular to an optical path drawn in the laser optical path. This light may pass through the polarizer 396. As described above, the optical shutter 310 may allow light to pass therethrough during application of the high voltage to the electro-optic crystal 395c.

The Pockets cell 394 has responsivity of about 1 ns, and is applicable as a high-speed optical shutter. Moreover, for example, an acousto-optical (AO) device may be used as the optical shutter 310. In this case, the AO device has responsivity of about several hundreds of ns; therefore, the AO device is applicable. Moreover, changing the voltage to be applied between the first electrode 395a and the second electrode 395b in response to control from the transmittance setter 311 makes it possible to vary transmittance.

It is to be noted that a polarizer and a λ/2 plate may be further included in an upstream-side optical path in addition to the configuration of the optical shutter 310 in FIG. 20 to serve as an optical isolator. Note that left side and right side of FIG. 20 may indicate upstream side and downstream side, respectively. In this case, when the predetermined high voltage is applied between the first electrode 395a and the second electrode 395b in the Pockels cell 394, the optical isolator may allow both light from the upstream side and light from downstream side to pass therethrough at high transmittance. In other words, the optical isolator may be opened. When the predetermined high voltage is not applied between the first electrode 395a and the second electrode 395b, the optical isolator may prevent both the light from the upstream side and the light from the downstream side from passing therethrough. In other words, the optical isolator may be closed.

### 7. Hardware Environment of Controller

A person skilled in the art will appreciate that a general-purpose computer or a programmable controller may be combined with a program module or a software application to execute any subject matter disclosed herein. The program module, in general, may include one or more of a routine, a program, a component, a data structure, and so forth that each causes any process described in any example embodiment of the present disclosure to be executed.

FIG. 21 is a block diagram illustrating an exemplary hardware environment in which various aspects of any subject matter disclosed therein may be executed. An exemplary hardware environment 100 in FIG. 21 may include a processing unit 1000, a storage unit 1005, a user interface 1010, a parallel input/output (PO) controller 1020, a serial I/O controller 1030, and an analog-to-digital (A/D) and digital-to-analog (D/A) converter 1040. Note that the configuration of the hardware environment 100 is not limited thereto.

The processing unit 1000 may include a central processing unit (CPU) 1001, a memory 1002, a timer 1003, and a graphics processing unit (GPU) 1004. The memory 1002 may include a random access memory (RAM) and a read only memory (ROM). The CPU 1001 may be any commercially-available processor. A dual microprocessor or any other multi-processor architecture may be used as the CPU 1001.

The components illustrated in FIG. 21 may be coupled to one another to execute any process described in any example embodiment of the present disclosure.

Upon operation, the processing unit 1000 may load programs stored in the storage unit 1005 to execute the loaded programs. The processing unit 1000 may read data from the storage unit 1005 together with the programs, and may write data in the storage unit 1005. The CPU 1001 may execute the programs loaded from the storage unit 1005. The memory 1002 may be a work area in which programs to be executed by the CPU 1001 and data to be used for operation of the CPU 1001 are held temporarily. The timer 1003 may measure time intervals to output a result of the measurement to the CPU 1001 in accordance with the execution of the programs. The GPU 1004 may process image data in accordance with the programs loaded from the storage unit 1005, and may output the processed image data to the CPU 1001.

The parallel I/O controller 1020 may be coupled to parallel I/O devices operable to perform communication with the processing unit 1000, and may control the communication performed between the processing unit 1000 and the parallel I/O devices. Non-limiting examples of the parallel I/O devices may include the synchronization controller 3, the exposure apparatus controller 5, the synchronous circuit 13, the amplifier controller 30, the charger 31, the shift amount adder 54, and the error controller 55. The serial I/O controller 1030 may be coupled to a plurality of serial I/O devices operable to perform communication with the processing unit 1000, and may control the communication performed between the processing unit 1000 and the serial I/O devices. Non-limiting examples of serial I/O devices may include the delay circuit 57 and the error controller 55. The A/D and D/A converter 1040 may be coupled to analog devices such as various kinds of sensors through respective analog ports. Non-limiting examples of the sensors may include the optical path length error detector 43. The A/D and D/A converter 1040 may control communication performed between the processing unit 1000 and the analog devices, and may perform analog-to-digital conversion and digital-to-analog conversion of contents of the communication.

The user interface 1010 may provide an operator with display showing a progress of the execution of the programs executed by the processing unit 1000, such that the operator is able to instruct the processing unit 1000 to stop execution of the programs or to execute an interruption routine.

The exemplary hardware environment 100 may be applied to one or more of configurations of the solid-state laser controller 14 and other controllers according to any example embodiment of the present disclosure. A person skilled in the art will appreciate that such controllers may be executed in a distributed computing environment, namely, in an environment where tasks may be performed by processing units linked through any communication network. In any example embodiment of the present disclosure, controllers such as an unillustrated controller for an exposure apparatus that integrally controls the solid-state laser controller 14, the synchronization controller 3, and the amplifier controller 30 may be coupled to one another through a communication network such as Ethernet (Registered Trademark) or the Internet. In the distributed computing environment, the program module may be stored in each of local and remote memory storage devices.

### 8. Et Cetera

The foregoing description is intended to be merely illustrative rather than limiting. It should therefore be appreciated that variations may be made in example embodiments of the present disclosure by persons skilled in the art without departing from the scope as defined by the appended claims.

The terms used throughout the specification and the appended claims are to be construed as “open-ended” terms. For example, the term “include” and its grammatical variants are intended to be non-limiting, such that recitation of items in a list is not to the exclusion of other like items that can be substituted or added to the listed items. The term “have” and its grammatical variants are intended to be non-limiting, such that recitation of items in a list is not to the exclusion of other like items that can be substituted or added to the listed items. Also, the singular forms “a”, “an”, and “the” used in the specification and the appended claims include plural references unless expressly and unequivocally limited to one referent.

What is claimed is:

1. A titanium-sapphire laser apparatus, comprising:
a continuous wave oscillation laser unit configured to perform continuous wave oscillation in a single longitudinal mode to output seed light;
an amplification oscillator where the seed light enters, and including an optical resonator and a titanium-sapphire crystal, the titanium-sapphire crystal being provided in an optical path in the optical resonator;
a pulsed laser unit configured to output pulsed laser light toward the titanium-sapphire crystal;
an error detector provided in an optical path of leak light of the seed light from the optical resonator, and configured to detect an optical path length error between an optical path length in the optical resonator and a positive integer multiple of a wavelength of the seed light and output an optical path length error signal;
an error controller configured to output a correction value of the optical path length error signal; and
an optical path length corrector configured to vary the optical path length in the optical resonator on a basis of a signal, the signal resulting from adding the correction value to the optical path error signal.

2. The titanium-sapphire laser apparatus according to claim 1, wherein the error controller calculates the correction value on a basis of the optical path length error signal inputted from the error detector within a predetermined period.

3. The titanium-sapphire laser apparatus according to claim 2, wherein the error controller calculates the correction value to allow the optical path length error to approach zero at a timing immediately before entry of the pulsed laser light into the titanium-sapphire crystal.

4. The titanium-sapphire laser apparatus according to claim 2, further comprising:
a synchronous circuit configured to output an oscillation trigger to the pulsed laser unit, the oscillation trigger controlling an output timing of the pulsed laser light;
an optical shutter provided in the optical path of the leak light between the optical resonator and the error detector; and
an optical shutter controller configured to perform, on a basis of the oscillation trigger, control in which the optical shutter is closed during entry of the seed light amplified in a form of pulse by the amplification oscillator into the optical shutter and the optical shutter is opened during non-entry of the seed light amplified in the form of pulse by the amplification oscillator into the optical shutter.

5. The titanium-sapphire laser apparatus according to claim 1, further comprising a band pass filter provided in the optical path in the optical resonator and configured to allow the seed light to selectively pass therethrough.

6. The titanium-sapphire laser apparatus according to claim 1, wherein the wavelength of the seed light is about 904 nm.

7. The titanium-sapphire laser apparatus according to claim 1, wherein the optical resonator is a ring optical resonator.

8. The titanium-sapphire laser apparatus according to claim 1, further comprising a first multipass amplifier including a first multipass optical system and a first titanium-sapphire crystal, the first multipass optical system allowing the seed light outputted from the amplification oscillator to reciprocate therethrough, and the first titanium-sapphire crystal being provided in a first multiple optical path in the first multipass optical system and being different from the titanium-sapphire crystal.

9. The titanium-sapphire laser apparatus according to claim 8, further comprising a second multipass amplifier including a second multipass optical system and a second titanium-sapphire crystal, the second multipass optical system allowing the seed light outputted from the first multipass amplifier to reciprocate therethrough, and the second titanium-sapphire crystal being provided in a second multiple optical path in the second multipass optical system and being different from the titanium-sapphire crystal,
wherein the number of reciprocations of the seed light in the second multipass amplifier is equal to or smaller than the number of reciprocations of the seed light in the first multipass amplifier.

10. The titanium-sapphire laser apparatus according to claim 9, further comprising a dispersing prism provided in an optical path between the first multipass amplifier and the second multipass amplifier.

11. The titanium-sapphire laser apparatus according to claim 8, wherein the first multipass optical system allows an incident beam image at a predetermined entry position in an optical path of the seed light in the first multipass optical system to be transferred onto the optical path of the seed light an even number of times to form an image of the incident beam image.

12. The titanium-sapphire laser apparatus according to claim 8, wherein
the first multipass optical system includes a first condenser lens and a second condenser lens,
an optical path length between the first condenser lens and the second condenser lens is substantially a sum of a focal length of the first condenser length and a focal length of the second condenser lens, and
the first titanium-sapphire crystal is provided substantially at a rear-side focal position of the first condenser lens between the first condenser lens and the second condenser lens.

13. The titanium-sapphire laser apparatus according to claim 12, wherein the focal length of the first condenser lens is substantially equal to the focal length of the second condenser lens.

14. The titanium-sapphire laser apparatus according to claim 12, wherein
the first multipass optical system includes a pair of turning back mirrors provided in an optical path of the seed light that has passed through one of the first condenser lens and the second condenser lens, the pair of turning back mirrors being configured to turn back the optical path of the seed light to the one of the first condenser lens and the second condenser lens, and
an optical path length of an optical path from the one of the first condenser lens and the second condenser lens via the pair of turning back mirrors to the one of the first condenser lens and the second condenser lens is substantially twice the focal length of the one of the first condenser lens and the second condenser lens.

15. The titanium-sapphire laser apparatus according to claim 14, wherein the focal length of the first condenser lens is substantially equal to the focal length of the second condenser lens.

16. A laser apparatus used for an exposure apparatus, the laser apparatus comprising:
a master oscillator power oscillator including a continuous wave oscillation laser unit, the continuous wave oscillation laser unit being configured to perform continuous wave oscillation in a single longitudinal mode to output seed light;
a first multipass amplifier including a first multipass optical system and a first titanium-sapphire crystal, the first multipass optical system allowing the seed light outputted from the master oscillator power oscillator to reciprocate therethrough, and the first titanium-sapphire crystal being provided in a first multiple optical path in the first multipass optical system; and
a second multipass amplifier including a second multipass optical system and a second titanium-sapphire crystal, the second multipass optical system allowing the seed light outputted from the first multipass amplifier to reciprocate therethrough, and the second titanium-sapphire crystal being provided in a second multiple optical path in the second multipass optical system,
the number of reciprocations of the seed light in the second multipass amplifier being equal to or smaller than the number of reciprocations of the seed light in the first multipass amplifier.

17. A titanium-sapphire amplifier, comprising:
a titanium-sapphire crystal;
a multipass optical system including a plurality of light condensing optical devices, and configured to allow seed light having entered via a predetermined entry position to pass through the titanium-sapphire crystal an even number of times and configured to allow an incident beam image at the predetermined entry position to be transferred by the plurality of light condensing optical devices an even number of times to form an image of the incident beam image;
a first dichroic mirror provided in an optical path of the seed light in the multipass optical system and provided to allow excitation light to enter the titanium-sapphire crystal; and
a second dichroic mirror provided in the optical path of the seed light in the multipass optical system and provided to allow the excitation light outputted from the titanium-sapphire crystal to be outputted to outside of the multipass optical system.

18. The titanium-sapphire amplifier according to claim 17, wherein
the plurality of light condensing optical devices each include a first condenser lens and a second condenser lens,
an optical path length between the first condenser lens and the second condenser lens is substantially a sum of a focal length of the first condenser lens and a focal length of the second condenser lens, and
the titanium-sapphire crystal is provided substantially at a rear-side focal position of the first condenser lens between the first condenser lens and the second condenser lens.

19. The titanium-sapphire laser amplifier according to claim 18, wherein the focal length of the first condenser lens is substantially equal to the focal length of the second condenser lens.

20. The titanium-sapphire amplifier according to claim 19, wherein
the multipass optical system includes a pair of turning back mirrors provided in an optical path of the seed light that has passed through one of the first condenser lens and the second condenser lens, the pair of turning back mirrors being configured to turn back the optical path of the seed light to the one of the first condenser lens and the second condenser lens, and
an optical path length of an optical path from the one of the first condenser lens and the second condenser lens via the pair of turning back mirrors to the one of the first condenser lens and the second condenser lens is substantially twice the focal length of the one of the first condenser lens and the second condenser lens.
